(19) United States
(12) Patent Application Publication
(10) Pub. No.: US 2004/0213246 A1
(43) Pub. Date: Oct. 28, 2004

(54) ASYNCHRONOUS TRANSFER MODE LAYER SIDE INTERFACE APPARATUS, PHYSICAL LAYER SIDE INTERFACE APPARATUS AND CELL PROCESSING METHOD AS WELL AS ASYNCHRONOUS TRANSFER MODE COMMUNICATION APPARATUS

(76) Inventors: Shigeo Tani, Osaka (JP); Yasuo Miyawaki, Osaka (JP); Hiroki Kondo, Osaka (JP)

Correspondence Address: KATTEN MUCHIN ZAVIS ROSENMAN, 575 MADISON AVENUE, NEW YORK, NY, 10022-2585, US

(21) Appl. No.: 09/794,584

(22) Filed: Feb. 27, 2001

(30) Foreign Application Priority Data
Jul. 19, 2000 (JP) 2000-219115

(51) Int. Cl. H04L 12/28

(52) U.S. Cl. 370/395.1; 370/449; 370/469

(57) ABSTRACT

The invention provides an improved ATM technique which can achieve common processing without depending upon the level or the mode of a cell used by the physical layer side, the bit width in the same mode, the parity adding method depending upon the level or the operation mode and the ATM layer side can cope individually with all modes where all cell information such as a level, a mode, presence or absence of a UDF, a bit width and a parity adding method is recognized in advance. An ATM communication apparatus includes a physical layer side interface apparatus which in turn includes a FIFO processing section and a UTOPIA interface section, and an ATM layer side interface apparatus which in turn includes a detection circuit, a UTOPIA circuit, and a selector.

### BACKGROUND OF THE INVENTION

1) Field of the Invention

This invention relates to a signal format between an ATM layer function and one or a plurality of physical layer functions typically for an ATM (Asynchronous Transfer Mode) communication apparatus, and more, particularly to an asynchronous transfer mode layer side interface apparatus, a physical layer side interface apparatus and a cell processing method as well as an asynchronous transfer mode communication apparatus suitable for use for polling control of the UTOPIA level 1, level 2 and level 3 based on the UTOPIA (Universal Test and Operations PHY Interface for ATM) prescribed by the ATM forum.

2) Description of the Related Art

In the ATM technique, packets corresponding to a plurality of kinds of logic are multiplexed and transmitted with one piece of hardware. A lower order layer of the transmission side divides a message from a higher order layer to produce a plurality of ATM cells of an equal size and transmits the ATM cells, and the reception side assembles the ATM cells to regenerate the message.

As well known in the art, the layer structure has a high order layer, an AAL layer (Adaptation AAL layer), an ATM layer and a physical layer from the high order side. The high order layer signifies typically an application program, and the AAL layer divides a packet from the high order layer into portions of a size equal to an integral number of times 48 bytes and performs other necessary processing. The ATM layer adds header information of 5 bytes to a payload of 48 bytes from the AAL layer to produce an ATM cell of 53 bytes and determines a transmission route and so forth for the ATM cell. The physical layer assembles ATM cells received from the ATM cells into a frame.

A signal interface between the physical layer and the ATM layer in the ATM mode is called UTOPIA (Universal Test & Operations PHY Interface for ATM).

FIG. 33 is a view illustrating a concept of the UTOPIA interface. Interface specifications which adopt the UTOPIA are standardized as a format of a transmission signal TxData, a transmission control signal TxControl, a reception signal RxData and a reception control signal RxControl between the ATM layer and the physical layer shown in FIG. 33. Electric interface specifications have been determined among member enterprises of the ATM forum, and particular contents thereof are disclosed in the “Utopia, An ATM-PHY Interface Specification”, UTOPIA Level 2, vol. 0 (af-phy-0039.000) and the like documents.

At present, the UTOPIA in the ATM system is not limited to one kind, but uses a plurality of UTOPIA levels (UTOPIA levels 1 to 3; in the following description, a UTOPIA level is sometimes referred to merely as level) and a plurality of polling methods for different applications. Here, the levels 1 to 3 represent different methods of transmission and reception of cells between the physical layer and the ATM layer, and the polling methods are methods regarding control.

The level 1 relates to an interface apparatus for single point connection and uses an interface which can connect main signals and control signals for transmission and reception in a one-by-one corresponding relationship. The level 2 relates to an interface apparatus for multi-point connection formed from a plurality of interface apparatus and uses an interface to which main signals of the individual interface apparatus are connected by a common bus and control signals of the plurality of interface apparatus are connected individually.

Meanwhile, the polling methods include a great number of setting modes of an octet level/cell level, a single Clav mode/direct status mode/multi-status mode and 8 bits/16 bits/32 bits. The setting modes are called UTOPIA modes (a UTOPIA mode may be hereinafter referred to simply as mode). At present, which one of the modes is used relies upon a level and a mode handled by the physical layer side or the ATM side.

In the following, the UTOPIA is described with reference to FIGS. 34 to 44.

FIG. 34 is a block diagram of an ATM communication apparatus (asynchronous transfer mode communication apparatus). The ATM communication apparatus 99 shown in FIG. 34 includes a physical layer side interface apparatus 110 and ATM layer interface apparatus 100 (only one is shown in FIG. 34).

The physical layer side interface apparatus 110 is connected to an ATM network 80 and outputs reception signals (RxData, RxPrty, RxSOC, RxClav) to the ATM layer interface apparatus 100. The physical layer side interface apparatus 110 includes a first-in first-out processing section (which may be hereinafter referred to as FIFO p processing section) A301 and a UTOPIA interface processing section A305.

RxData (Reception Data) mentioned above is information data, and RxPrty (Reception Parity) is a parity bit added to the information data. RxSOC (Reception Start Of Cell) is a signal indicative of the top octet (header H1) of an ATM cell. RxClav (Reception Cell Available) is a cell reception allowance signal in the form of an active-high three-state signal. Though not shown, RxClk represents a reception clock of a clock cycle sent from the physical layer side interface apparatus 110 to the ATM layer interface apparatus 100.

Each of the ATM layer interface apparatus 100 outputs reception signals (RxEnb, RxAdd) to the physical layer side interface apparatus 110. RxEnb (Reception Enable) is a signal indicating that reception is enabled. RxAddr indicates a reception address signal (physical layer side port number) and is 5-bit data used to poll and select a predetermined one of the ATM layer interface apparatus 100.

Thus, polling is performed in the following manner. First, when the physical layer side interface apparatus 110 receives an ATM cell which is a data cell, then the ATM cell is written into a memory A302 in the FIFO processing section A301 under the control of a write control section (denoted by W_CNT) A303. After the writing is completed, RxClav of ‘H’ (presence of write data) is transmitted from the UTOPIA interface processing section A305 to a UTOPIA circuit (denoted by UTOPIA circuit) A306 of the pertaining ATM layer interface apparatus 100 under the control of a read control section (denoted by R_CNT) A304.

When the UTOPIA circuit A306 of the ATM layer interface apparatus 100 receives RxClav=‘H’, it transmits RxEnb=‘L’ (Active) to the UTOPIA interface processing section A305 of the physical layer side interface apparatus 110. Where the physical layer side interface apparatus 110 has a plurality of ports, the UTOPIA circuit A306 transmits RxAddr (physical layer side port number) together with RxEnb.

Then, the UTOPIA interface processing section A305 of the physical layer side interface apparatus 110 reads out an ATM cell from the memory A302 at a predetermined timing controlled by the read control section A304 based on RxEnb received from the ATM layer interface apparatus 100 (where the physical layer side interface apparatus 110 includes a plurality of physical layer side ports, based on RxEnb and RxAddr). Further, the UTOPIA interface processing section A305 performs format conversion such as addition of RxPrty and transmits the ATM cell to the ATM layer interface apparatus 100 together with RxSOC (a frame timing indicative of the top of the cell).

Accordingly, in order to select a particular one of the ATM layer interface apparatus 100, the physical layer side interface apparatus 110 outputs an address of the ATM layer interface apparatus 100. Then, one of the ATM layer interface apparatus 100 the address of which itself is equal to the address receives the outputted address and can discriminate that data destined for the ATM layer interface apparatus 100 itself has been transmitted.

Then, if the polled physical layer side interface apparatus 110 can process transfer of one complete ATM cell, then it raises (asserts) RxClav to ‘H’ for a time of a clock cycle next to the clock at which the address has been outputted.

One physical terminating interface apparatus and one or a plurality of ATM terminating interface apparatus can be connected to each other in this manner.

Cell formats of the UTOPIA are illustrated in FIGS. 35(a) to 40. FIG. 35(a) is a view illustrating a cell format used commonly by the levels 1 to 3 and illustrates a cell format in the 8-bit mode common to the levels 1 to 3. FIG. 35(b) is a view illustrating a cell format used commonly in the levels 1 to 3 and illustrates a cell format in the 16-bit mode common to the levels 1 to 3. FIG. 36(a) is a view illustrating a cell format in the 8-bit mode of the level 3, and FIG. 36(b) is a view illustrating a cell format in the 16-bit mode of the level 3.

The difference between FIGS. 35(a) and 36(a) and the difference between FIGS. 35(b) and 36(b) reside in whether or not a UDF (User Defined) is included between the Header part and the Payload part.

FIGS. 37(a) and 37(b) are views illustrating cell formats in the 32-bit mode unique to the level 3, and FIG. 37(a) illustrates a cell format in the 14×32-bit mode of the level 3 while FIG. 37(b) illustrates a cell format in the 13×32-bit mode of the level 3. Also the difference between the cell formats of FIGS. 37(a) and 37(b) relates to the UDF.

Accordingly, the UTOPIA circuit A306 of the ATM layer interface apparatus 100 cannot discriminate a cell transfer method of what level and what mode is used until data (an ATM cell) are actually transmitted thereto from the physical layer side interface apparatus 110.

Therefore, the UTOPIA circuit A306 must confirm the level and the mode of data (an ATM cell) transfer used by the physical layer side interface apparatus 110 and set a level and a mode corresponding to the cell format in advance. Further, the UTOPIA circuit A306 must take an individual countermeasure to select a level and a mode of the ATM side depending upon an ATM cell transfer method of the physical layer side.

In particular, according to the method described above, even if it is discriminated that the interface used is the 8-bit mode, whether the level 1 or 2 (the format of FIG. 35(a)) or the level 3 (the format of FIG. 36(a) or 36(b)) should be used depends upon presence or absence of a UDF between the Header part and the Payload as seen in FIGS. 35(a) and 36(a). This gives rise to such differences as described in (1-1) to (1-5) below.

(1-1) On the difference in description of the level

Even if it is discriminated that the interface used is the 16-bit mode, whether the level 1 or 2 (the format of FIG. 35(a)) or the level 3 (the format of FIG. 36(a)) should be used depends upon presence or absence of a UDF as seen in FIGS. 35(a) and 36(a).

(1-2) On the difference in discrimination of presence or absence of a UDF

When the 32-bit mode is used, the level can be discriminated. However, since the 32-bit mode is a format unique to the level 3, different formats are applicable also with the same level like the formats illustrated in FIGS. 37(a) and 37(b) which are different in presence or absence of a UDF between the Header part and the Payload part.

(1-3) On the difference in discrimination of the bit width

In the level 1 or 2, the 8-bit mode and the 16-bit mode are applicable as illustrated in FIGS. 35(a) and 35(b), respectively.

Further, in the level 3, four different modes of the 8-bit mode, 16-bit mode, 14×32-bit mode and 13×32-bit mode are applicable as seen in FIGS. 36(a), 36(b), 37(a) and 37(b) Therefore, the bit width is different even depending upon the difference in level among the levels 1 to 3.

(1-4) On the difference in discrimination of the adding method of RxPrty

As regards addition of RxPrty in the 16-bit mode, in the level 2 or 3, an odd parity is added to all 16 bits of RxData[15:0] representative of ATM cell data. On the other hand, in the level 1, an odd parity RxPrty[1] is added to the high order 8 bits of RxData[15:0] while an odd parity RxPrty[0] is added to the low order 8 bits. Accordingly, also in regard to addition of parity, the processing method is different between the level 2 or 3 and the level 1.

(1-5) On the difference in discrimination of a processing operation mode

Now, differences in discrimination of a processing operation mode are described with reference to FIGS. 38 to 44.

FIG. 38 is a time chart illustrating an octet-level process, and FIG. 39 is a time chart illustrating a cell-level process. The octet-level process illustrated in FIG. 38 is a method wherein a cell is processed for each one byte, and the cell-level process illustrated in FIG. 39 is a method wherein a cell is processed for each one cell.

In particular, in the octet-level process, since a cell is processed in a unit of a byte by control of the physical layer side, a free portion (B101 of RxData) shown in FIG. 38 is produced in data, and RxData is outputted.

On the other hand, in the cell-level process, once the top (B201) of the cell illustrated in FIG. 39 is outputted, the physical layer side cannot perform an outputting operation until outputting of the last (B202) of the cell is completed. It is to be noted that, in both processes, when the physical layer side receives RxEnb=‘H’ from the ATM side like B102 illustrated in FIG. 38 or B203 illustrated in FIG. 39, invalid cell data (B103 illustrated in FIG. 38 and B204 illustrated in FIG. 39) is outputted.

Further, the latter cell-level process has three operation modes. In particular, the cell-level process has a single Clav-mode, a direct status-mode and a multiplexed status-mode.

The first single Clav-mode is described first. FIG. 40 is a time chart in the single Clav-mode. The ATM communication apparatus here has the same construction as that shown in FIG. 34. RxAddr illustrated in FIG. 40 is an address from the ATM side, and referring to the address at RxClav=‘H’, the physical layer side interface apparatus 110 outputs data of the physical layer N−3 at a point of time of B301 (which may be hereinafter represented like time point B301) and outputs data of the physical layer N+3 at another time point B302. It is to be noted that the physical layer N−3 is represented as PHY N−3, and such representation is applied also to other data.

Here, within a period till a time point B303 including the time points B301 and B302, since the directly preceding physical layer N is being outputted, the data of the physical layer N−3 is not outputted. Then, after the outputting of the cell of the physical layer N is completed, data of the physical layer N+3 is outputted at a next read enabled time point B304 (time point B305).

Now, the second direct status-mode is described.

FIG. 41 is a block diagram in the direct status-mode, and FIG. 42 is a time chart in the direct status-mode. In one ATM layer interface apparatus 100a (represented as ATN layer device) shown in FIG. 41, four physical layer side interface apparatus 110a to 110d (represented as PHY device) are connected to the one ATM layer.

Referring to RxAddr shown in FIG. 42, since the Port #1 of RxClav1 is ‘H’ (which signifies that outputting is enabled) for RxAddr=‘1’ at the time point B501, RxData is outputted from the Port #1 at the time point B502.

Further, at the time point B503, since RxClav3=‘H’ for RxAddr=3 and the Port #3 can output, RxData begins to be outputted from the Port #3 at the time point B504 and continues to be outputted till the time point B505. Then, at the time point B505, since RxData=‘X’ (don't care) (B506) and RxClav=‘H’ is exhibited only for the Port #3, RxData is outputted from the Port #3 (B507).

Further, the third multiplexed status-mode is described. FIG. 43 is a block diagram in the multiplexed status-mode, and FIG. 44 is a time chart in the multiplexed status-mode. To one ATM layer interface apparatus 100b shown in FIG. 43, eight physical layer side interface apparatus (those which are represented as PHY device #1 to PHY device #8) are connected.

At the time point B701 illustrated in FIG. 44, data #0, #1, #2 and #3 (ATM cell) can be read out. However, since RxAddr from the ATM side is ‘1’ at the time point B702, the ATM cell of #1 is outputted as RxData (B703). Further, at the time point B704, ATM cells #24, #25, #26 and #27 can be read out. However, since RxAddr at the time point B705 is “25”, the data of #25 is outputted as RxData at the time point B706.

In this manner, differences appear also in discrimination of a processing operation mode.

Accordingly, as described in (1-1) to (1-5) above, where the conventional system is used, \mathring{1} the cell format used is different depending upon the level or mode of a cell used by the physical layer side, and \mathring{2} the bit width is different also in the same mode, and further, \mathring{3} the parity adding method is different depending upon the level as well, and besides, \mathring{4} the processing method is different also depending upon the operation mode.

However, it is requested that the ATM communication apparatus are ready for all of the modes described above, and it is necessary that the UTOPIA specifications be common to all of the modes. Accordingly, it is necessary for the UTOPIA circuit of the ATM side to cope individually with all of the modes while all cell information such as a level, a mode, presence or absence of the UDF, a bit width and a parity adding method is recognized in advance.

### SUMMARY OF THE INVENTION

It is an object of the present invention to provide an asynchronous transfer mode layer side interface apparatus, a physical layer side interface apparatus and a cell processing method as well as an asynchronous transfer mode communication apparatus wherein common processing is possible without depending upon \mathring{1} the level or mode of a cell used by the physical layer side, \mathring{2} the bit width in the same mode, \mathring{3} the parity adding method depending upon the level and \mathring{4} the operation mode and the ATM layer side can cope with all modes individually while all cell information such as a level, a mode, presence or absence of a UDF, a bit width and a parity adding method is recognized in advance.

In order to attain the object described above, according to an aspect of the present invention, there is provided an asynchronous transfer mode layer side interface apparatus which uses an interface representative of a signal interface between a physical layer and an asynchronous transfer mode layer in an asynchronous transfer mode, comprising a detection circuit connected to a physical layer side interface apparatus and capable of extracting physical layer data regarding the interface from an interface signal outputted from the physical layer side interface apparatus and outputting data originating from the physical layer data and first address information, a circuit connected to the detection circuit and capable of outputting information data received by the physical layer side interface apparatus to a higher order layer based on the physical layer data and outputting second address information, and a selection section connected to the detection circuit and the circuit and capable of selectively outputting the first address information and the second address information.

The asynchronous transfer mode layer side interface apparatus is advantageous in that it can cope with all of the modes of the interface specifications without setting from the outside and ATM cell data can be communicated effectively.

The detection circuit may include a level-mode detection section connected to the physical layer side interface apparatus and capable of detecting at least a level, a mode and a polling method from the physical layer data, a physical layer number detection section connected to the physical layer side interface apparatus and capable of detecting the number of connection ports of the physical layer side interface apparatus, a bit width-cell length detection section capable of detecting at least a bit width and a cell length of the interface signal, and a control section connected to the level-mode detection section and the physical layer number detection section and capable of outputting data based on the level, mode and polling method detected by the level-mode detection section, a start signal representing that a cell of the asynchronous transfer mode has been received and a selection signal for switching between the detection circuit and the circuit.

The asynchronous transfer mode layer side interface apparatus is advantageous in that it can achieve common processing without depending upon the level or the mode of a cell used by the physical layer side, the bit width in the same mode, the parity adding method which depends upon the level or the operation mode.

The detection circuit may extract, from a Clav signal having status information representative of whether or not reception of an asynchronous transfer mode call is possible, the status information and an inspection result regarding at least a level and a mode and set physical layer data regarding the interface.

According to another aspect of the present invention, there is provided a physical layer side interface apparatus which uses an interface representative of a signal interface between a physical layer and an asynchronous transfer mode layer in an asynchronous transfer mode, comprising holding means capable of holding an initialization cell to be used to detect physical layer data regarding the interface, write side detecting cell production means connected to the input side of the holding means and capable of writing the initialization cell, read side detecting cell production means connected to the output side of the holding means and capable of writing the initialization cell, and switching means connected to the write side detecting cell production means and the read side detecting cell production means and capable of selectively switching so that one of the write side detecting cell production means and the read side detecting cell production means is write enabled and the other of the write side detecting cell production means and the read side detecting cell production means is write inhibited.

The physical layer side interface apparatus is advantageous in that mode setting is automatically detected by hardware and setting in accordance with an operation condition by a user is not required any more. The physical layer side interface apparatus is advantageous also in that ATM cells can be transferred in a high efficiency and with a high quality and expandability and universality can be anticipated.

According to a further aspect of the present invention, there is provided a cell processing method for an asynchronous transfer mode layer side interface apparatus which uses an interface representative of a signal interface between a physical layer and an asynchronous transfer mode layer in an asynchronous transfer mode, comprising a writing step performed by a physical layer side interface apparatus of writing an initialization cell to be used to detect physical layer data regarding the interface, a detection step performed by the asynchronous transfer mode layer side interface apparatus of detecting physical layer data regarding the interface from a signal having a level and a mode, and a reception cell processing step performed by the asynchronous transfer mode layer side interface apparatus of outputting information data and second address information received by the physical layer side interface apparatus based on the physical layer data obtained by the detection step to a higher order layer.

The cell processing method is advantageous in that the circuit of the ATM side can cope individually with all modes where all cell information such as a level, a mode, presence or absence of a UDF, a bit width and a parity adding method is recognized in advance.

According to a still further aspect of the present invention, there is provided a cell processing method between a physical layer side interface apparatus and an asynchronous transfer mode layer side interface apparatus which uses an interface representative of a signal interface between a physical layer and an asynchronous transfer mode layer in an asynchronous transfer mode, comprising a switching step of selectively switching one of input side writing means and output side writing means in order to write an initialization cell provided in the physical layer side interface apparatus into holding means which is capable of storing the initialization cell, a cell writing step performed by the writing means selected by the switching step of writing the initialization cell into the holding means, and a processing step of permitting, when the input side writing means is selected, inputting of a clock signal outputted from the asynchronous transfer mode layer side interface apparatus to allow the initialization cell to be written into the holding means but reading out, when the output side writing means is selected, the initialization cell while masking part of a read enable flag stored in the holding means and then canceling the masking of the read enable flag to allow the initialization cell to be written into the holding means.

The cell processing method is advantageous in that it can cope with all of the modes of the interface specifications without setting from the outside and ATM cell data can be communicated effectively and besides the scale of hardware can be reduced.

According to a yet further aspect of the present invention, there is provided an asynchronous transfer mode communication apparatus which uses an interface representative of a signal interface between a physical layer and an asynchronous transfer mode layer in an asynchronous transfer mode, comprising a physical layer side interface apparatus for transmitting and receiving an interface signal, and an asynchronous transfer mode layer side interface apparatus for transmitting and receiving the interface signal, the asynchronous transfer mode layer side interface apparatus including a detection circuit connected to the physical layer side interface apparatus and capable of extracting physical layer data regarding the interface from an interface signal outputted from the physical layer side interface apparatus and outputting data originating from the physical layer data and first address information, a circuit connected to the detection circuit and capable of outputting information data received by the physical layer side interface apparatus to a higher order layer based on the physical layer data and outputting second address information, and a selection section connected to the detection circuit and the circuit and capable of selectively outputting the first address information and the second address information, the physical layer side interface apparatus including holding means capable of holding an initialization cell to be used to detect physical layer data regarding the interface, write side detecting cell production means connected to the input side of the holding means and capable of writing the initialization cell, read side detecting cell production means connected to the output side of the holding means and capable of writing the initialization cell, and switching means connected to the write side detecting cell production means and the read side detecting cell production means and capable of selectively switching so that one of the write side detecting cell production means and the read side detecting cell production means is write enabled and the other of the write side detecting cell production means and the read side detecting cell production means is write inhibited.

The above and other objects, features and advantages of the present invention will become apparent from the following description and the appended claims, taken in conjunction with the accompanying drawings in which like parts or elements denoted by like reference symbols.

### BRIEF DESCRIPTION OF THE DRAWINGS

FIG. 1 is a block diagram illustrating the principle of an asynchronous transfer mode communication apparatus of the present invention;

FIG. 2 is a block diagram of a detection circuit according to an embodiment of the present invention;

FIG. 3 is a block diagram of a UTOPIA circuit according to the embodiment of the present invention;

FIG. 4 is a block diagram of an asynchronous transfer mode communication apparatus according to the embodiment of the present invention;

FIG. 5 is a block diagram of a physical layer side interface apparatus according to the embodiment of the present invention;

FIG. 6 is a block diagram of an ATM side detection circuit according to the embodiment of the present invention;

FIG. 7 is a view showing an example of a cell format;

FIG. 8 is a time chart of the physical layer side when initial setting is selected by the write side;

FIG. 9 is a time chart of the physical layer side when initial setting is selected by the read side;

FIG. 10 is a time chart of the physical layer side when initial setting is selected by the write side;

FIG. 11 is a time chart of the physical layer side when initial setting is selected by the read side;

FIG. 12 is a time chart of the physical layer side when initial setting is selected by the write side;

FIG. 13 is a time chart of the physical layer side when initial setting is selected by the read side;

FIG. 14 is a time chart of the physical layer side when initial setting is selected by the write side;

FIG. 15 is a time chart of the physical layer side when initial setting is selected by the read side;

FIG. 16 is a time chart of the physical layer side when initial setting is selected by the write side;

FIG. 17 is a time chart of the physical layer side when initial setting is selected by the read side;

FIG. 18 is a time chart of the physical layer side when initial setting is selected by the write side;

FIG. 19 is a time chart of the physical layer side when initial setting is selected by the read side;

FIGS. 20 to 27 are time charts illustrating different operations of the detection circuit;

FIG. 28 is a flow chart illustrating operation of a control section;

FIG. 29 is a view illustrating data upon discrimination of the control section;

FIG. 30 is a flow chart illustrating operation of a level-mode detection section;

FIG. 31 is a flow chart illustrating operation of a bit width-cell length detection section;

FIG. 32 is a flow chart illustrating operation of a physical layer number detection section;

FIG. 33 is a view illustrating a concept of a UTOPIA interface;

FIG. 34 is a block diagram of an ATM communication apparatus;

FIG. 35(a) is a view showing a cell format used commonly for the levels 1 to 3;

FIG. 35(b) is a view showing another cell format used commonly for the level 1 to 3;

FIG. 36(a) is a view showing a cell format for an 8-bit mode of the level 3;

FIG. 36(b) is a view showing a cell format for a 16-bit mode of the level 3;

FIG. 37(a) and 37(b) are views showing cell formats unique to a 32-bit mode of the level 3;

FIG. 38 is a time chart illustrating an octet-level process;

FIG. 39 is a time chart illustrating a cell-level process;

FIG. 40 is a time chart in a single Clav mode;

FIG. 41 is a block diagram in a direct status mode;

FIG. 42 is a time chart in the direct status mode;

FIG. 43 is a block diagram in a multiplexed status mode; and

FIG. 44 is a time chart in the multiplexed status mode.

### DESCRIPTION OF THE PREFERRED EMBODIMENT

In the following, an embodiment of the present invention is described.

### A. Description of an Embodiment of the Invention

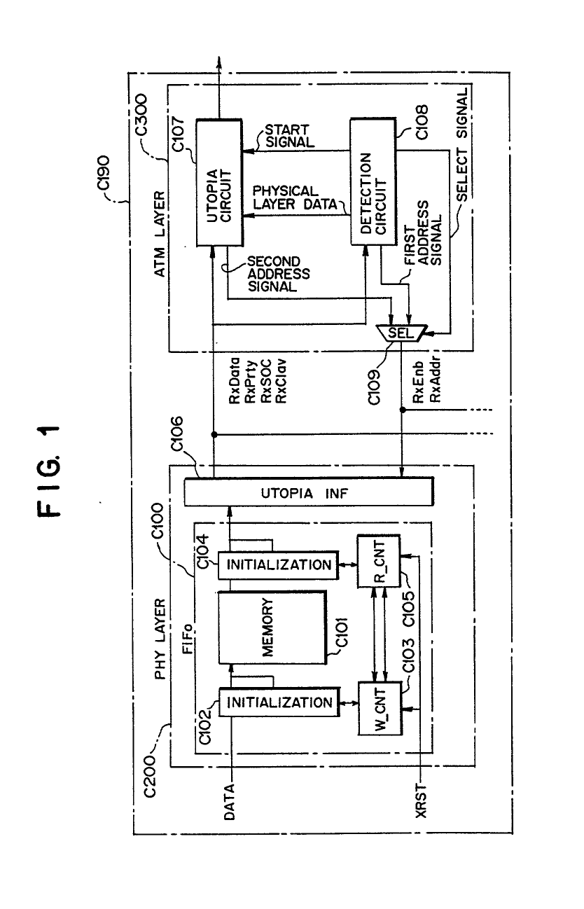

FIG. 1 is a block diagram illustrating the principle of an asynchronous transfer mode communication apparatus of the present invention. Referring to FIG. 1, an ATM communication apparatus (asynchronous transfer mode communication apparatus) C190 is an asynchronous transfer mode communication apparatus which uses a UTOPIA interface representative of a signal interface between the physical layer and the ATM layer in an ATM and includes a physical layer side interface apparatus C200 (represented as PHY layer) for transmitting and receiving a UTOPIA interface signal and asynchronous transfer mode layer side interface apparatus C300 (represented as ATM layer) (only one is shown in FIG. 1) for transmitting and receiving a UTOPIA interface signal.

It is to be noted that, in the following description, the physical layer side interface apparatus C200 is sometimes referred to simply as PHY layer C200. Further, the asynchronous transfer mode layer side interface apparatus C300 are sometimes referred to ATM layer side interface apparatus C300.

The physical layer side interface apparatus C200 includes a FIFO processing section C100 and a UTOPIA interface section (represented as UTOPIA INF) C106.

The FIFO processing section C100 is capable of holding an initialization cell for detecting physical layer data regarding the UTOPIA interface and includes a memory C101 (holding means). A write side detecting cell production section C102 (represented as initialization) is connected to the input side of the memory C101, and a write control section C103 (represented as W_CNT) is connected to the write side detecting cell production section C102. A read side detecting cell production section C104 (represented as initialization) is connected to the output side of the memory C101, and a read control section C105 (represented as R_CNT) is connected to the read side detecting cell production section C104. The write control section C103 and the read control section C105 cooperate with each other to function as switching means.

The write side detecting cell production section C102 is connected to the input side of the memory C101 and is capable of writing an initialization cell. The read side detecting cell production section C104 is connected to the output side of the memory C101 and is capable of writing an initialization cell.

The switching means (write control section C103 and read control section C105) is connected to the write side detecting cell production section C102 and the read side detecting cell production section C104 and is capable of selectively switching the write side detecting cell production section C102 and the read side detecting cell production section C104 so that one of them operates while the other is inoperative.

In other words, an initialization cell production function is provided on both of the write side and the readout side. The two production functions are not used simultaneously with each other, but one of them is selectively used in accordance with the necessity. Thus, the equivalent production functions are obtained.

It is to be noted that, where a plurality of physical layers (which signifies ports for a plurality of physical layer signals or of a plurality of physical layer side interface apparatus) are connected to the ATM layer, the physical layer side interface apparatus C200 includes FIFO processing sections C100 having the same function in all of the physical layers. Consequently, even where a plurality of physical layers are involved, a desired address can be allocated to each of the physical layers, and detection or an address necessary for a detection process can be allocated to each of the physical layers.

The UTOPIA interface section C106 reads out an ATM cell from the memory C101 at a predetermined timing based on RxEnb received from the ATM layer side interface apparatus C300, performs format conversion such as addition of RxPrty, and then transmits the data ATM cell to the ATM layer side interface apparatus C300 together with RxSOC.

Consequently, the FIFO processing section C100 produces an initialization cell having an initial state and detects a level, a mode and so forth.

The asynchronous transfer mode layer side interface apparatus C300 shown in FIG. 1 includes a detection circuit C108, a UTOPIA circuit C107, and a selector (selection section) C109.

The detection circuit C108 is connected to the physical layer side interface apparatus C200 and can detect physical layer data (PHY layer data) regarding the UTOPIA interface from a signal having a UTOPIA level and a UTOPIA mode and output data originating from the physical layer data and first address information. Further, the detection circuit C108 controls operation of the entire detection circuit C108 to detect physical layer data (a UTOPIA function) in the ATM layer.

The UTOPIA circuit C107 is connected to the detection circuit C108 and is capable of outputting information data to a higher order layer based on the physical layer data and outputting second address information.

The selector C109 is connected to the detection circuit C108 and the UTOPIA circuit C107 and is capable of selectively outputting the first address information and the second address information. In particular, RxEnb and RxAddr to be transmitted to the physical layer side interface apparatus C200 are selected and outputted by one of the UTOPIA circuit C107 and the detection circuit C108.

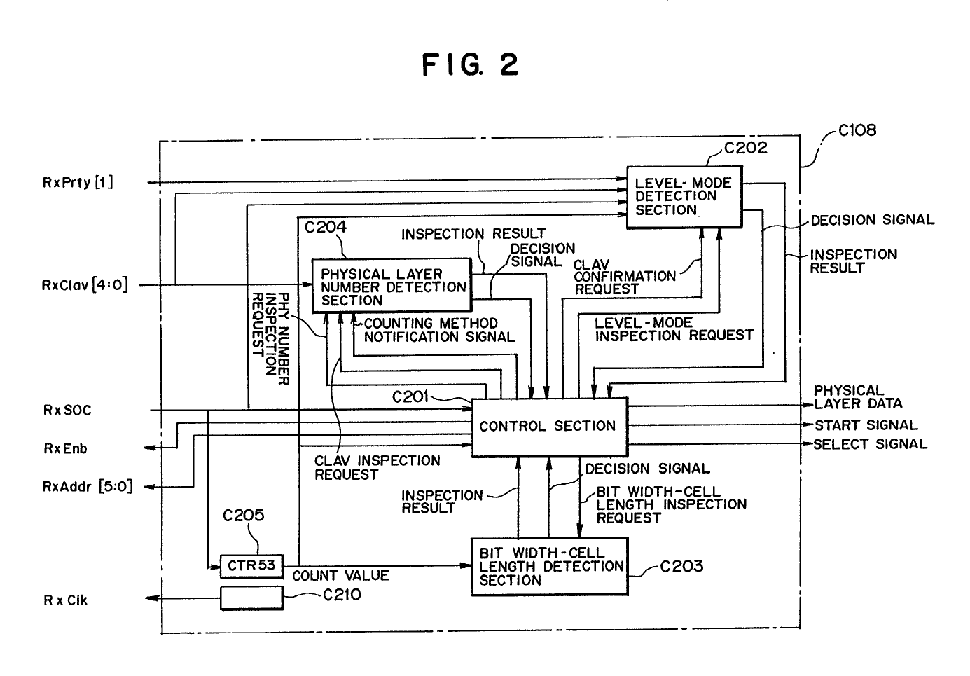

FIG. 2 is a block diagram of the detection circuit C108 according to an embodiment of the present invention. The detection circuit C108 shown in FIG. 2 includes four different blocks of a level-mode detection section C202, a physical layer number detection section C204, a bit width-cell length detection section C203 and a control section C201. The detection circuit C108 further includes a 53-nary counter C205 and a clock outputting section C210.

The level-mode detection section C202 is connected to the physical layer side interface apparatus C200 and is capable of detecting at least a UTOPIA level, a UTOPIA mode and a polling method from physical layer data.

The physical layer number detection section C204 is connected to the physical layer side interface apparatus C200 and is capable of detecting the number of connection ports of the physical layer side interface apparatus C200. The bit width-cell length detection section C203 is capable of detecting at least a bit width and a cell length of an interface signal.

The control section C201 is connected to the level-mode detection section C202 and the physical layer number detection section C204 and is capable of outputting data (physical layer data) based on a UTOPIA level, a UTOPIA mode and a polling method detected by the level-mode detection section C202, a start signal representing that an ATM cell has been received, and a select signal for switching between the detection circuit C108 and the UTOPIA circuit C107. The select signal functions as first address information.

In particular, the physical layer data is a signal for notifying the UTOPIA circuit C107 of a level and a mode, a bit width and a cell length, and the number of physical layers. The start signal is a signal for indicating starting or stopping of the UTOPIA circuit C107. The select signal is outputted to the selector C109 and used for the selector C109 to select whether a signal outputted from the UTOPIA circuit C107 or another signal outputted from the detection circuit C108 should be used as a signal of RxEnb and RxAddr to be transmitted to the physical layer side interface apparatus C200.

The 53-nary counter C205 (represented as CTR53) counts 53 clocks. The clock outputting section C210 produces RxClk and typically is an oscillator.

Thus, the control section C201 outputs an inspection request to the level-mode detection section C202, bit width-cell length detection section C203 and physical layer number detection section C204. Each of the blocks performs an inspection regarding an item which is an object of the inspection request while the inspection request signal is outputted.

More particularly, the control section C201 outputs a Clav confirmation request to the level-mode detection section C202. The Clav confirmation request is a signal for conveying a timing at which the level-mode detection section C202 should confirm what bit or bits among bits of RxClav are ‘H’. The control section C201 further outputs an inspection request for a bit width and a cell length of data to be communicated between the physical layer and the ATM layer to the bit width-cell length detection section C203.

Furthermore, the control section C201 outputs a counting method notification signal to the physical layer number detection section C204. The notification signal is outputted in order to convey a method of counting the number of physical layers so that a different counting method may be applied depending upon the difference in level or mode. Further, the control section C201 produces signals (physical layer data, a start signal and a select signal) to be outputted to the outside of the detection circuit C108.

On the other hand, the level-mode detection section C202 detects the level and the mode of each physical layer, and the physical layer number detection section C204 counts the number of physical layers while the 53-nary counter C205 counts 53 clocks.

Each of the level-mode detection section C202, bit width-cell length detection section C203 and physical layer number detection section C204 outputs an inspection result thereof to the control section C201. The inspection results are contents of the items of objects of the inspection requests and are used to notify the control section C201 when the inspection of the pertaining block is ended.

Here, decision signals having the same timings as those of the inspection results are conveyed to the control section C201 together with the inspection results. Further, once the two kinds of signals are outputted, they continue to be outputted until the inspection requests are cancelled so that the validity of the inspection results is secured.

The 53-nary counter C205 conveys (transfers) its count value to any block by which the count value is required.

Accordingly, it is considered that the detection circuit C108 is constructed so as to extract, from a Clav signal having status information representative of whether reception of an asynchronous transfer mode cell is possible/impossible, the status information and an inspection result regarding at least the UTOPIA level and the UTOPIA mode and set physical layer data regarding the UTOPIA.

In this manner, the detection circuit C108 detects a level and a mode, a bit width and a cell length, and the number of physical layers through the construction of the five different blocks.

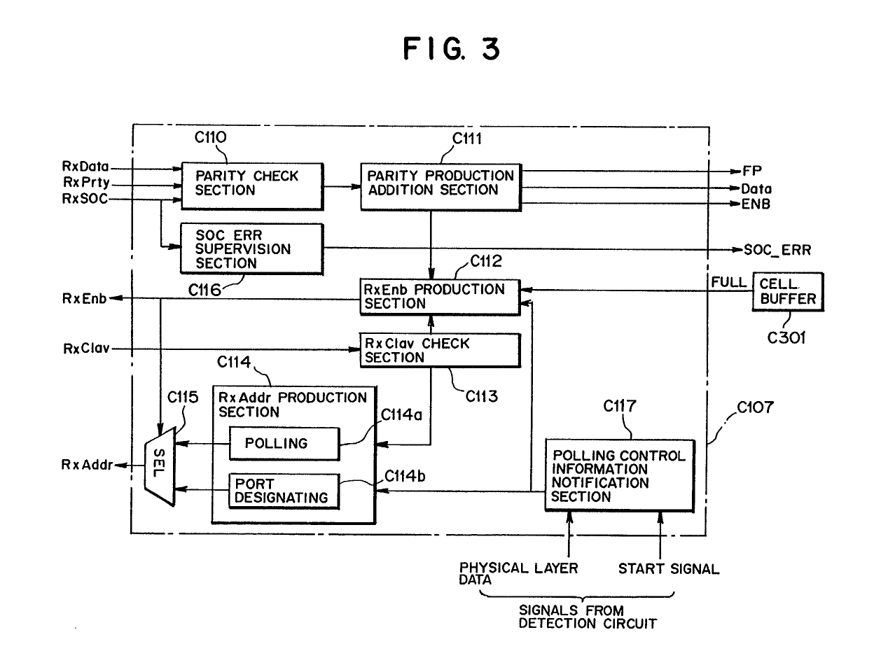

FIG. 3 is a block diagram of the UTOPIA circuit C107 according to the embodiment of the present invention. The UTOPIA circuit C107 shown in FIG. 3 includes a parity check section C110, a parity production addition section C111, a RxEnb production section C112, a RxClav check section C113, a RxAddr production section C114 including a polling production section C114a and a port designating production section C114b, a selector C115, a top octet cell fault supervision section C116, and a polling control information notification section C117. A cell buffer C301 for holding an ATM cell is connected to the UTOPIA circuit C107.

The parity check section C110 receives RxData and RxPrty and performs a parity inspection of data. The parity check section C110 thus functions as a parity checking section for input data. The top octet cell fault supervision section C116 receives RxSOC, and sets a flag of SOC_ERR to ‘H’ if RxSOC is abnormal, but sets the flag of SOC_ERR to ‘L’ if RxSOC is not abnormal. The top octet cell fault supervision section C116 outputs the flag of SOC_ERR thus set.

The parity production addition section C111 produces a parity, adds the produced parity to data outputted from the parity check section C110 and outputs FP, data (Data) and an enable signal (ENB). The RxClav check section C113 receives RxClav outputted from the physical layer side interface apparatus C200 and inspects RxClav, and outputs a result of the inspection to the RxEnb production section C112 and the RxAddr production section C114.

The RxEnb production section C112 receives data from the parity production addition section C111, an inspection result outputted from the RxClav check section C113, a signal (FULL) held in the cell buffer C301 and a control signal from the polling control information notification section C117 to produce RxEnb and outputs RxEnb to the selector C109 (refer to FIG. 1).

The polling control information notification section C117 receives physical layer data and a start signal (START signal) from the detection circuit C108 and outputs polling control information to the RxEnb production section C112 and the RxAddr production section C114.

The RxAddr production section C114 receives an inspection result outputted from the RxClav check section C113 and a control signal outputted from the polling control information notification section C117 and outputs RxAddr. The RxAddr production section C114 includes the polling production section C114a for producing RxAddr for polling and the port designating production section C114b for producing RxAddr for designating a port.

The selector (SEL) C115 selects RxAddr from the polling production section C114a and RxAddr from the port designating production section C114b in accordance with RxEnb outputted from the RxEnb production section C112 and outputs the selected RxAddr as second address information.

The UTOPIA circuit C107 of the ATM layer must cope with all UTOPIA functions, and therefore, the physical layer side interface apparatus C200 has all possible kinds of signals. Therefore, the UTOPIA circuit C107 sometimes receives unnecessary signals as well depending upon the type of a physical layer or the number of physical layers connected. In this instance, the UTOPIA circuit C107 pulls down such unnecessary signals. In other words, the UTOPIA circuit C107 keeps the values of the signals fixed to ‘L’ Also a tri-state signal (signal of a data line) outputted from the physical layer is pulled down by the UTOPIA circuit C107.

Now, a detection procedure is described. The cell processing method of the present invention is a cell processing method between a physical layer side interface apparatus and an asynchronous transfer mode layer side interface apparatus which uses a UTOPIA interface representative of a signal interface between the physical layer and the asynchronous transfer mode layer in the asynchronous transfer mode.

First, in order to write an initialization cell provided in the physical layer side interface apparatus into the FIFO processing section C100 which can hold the initialization cell, the write side detecting cell production section C102 (input side writing means) or the read side detecting cell production section C104 (output side writing means) is selectively switched (switching step).

Then, one of the write side detecting cell production section C102 and the read side detecting cell production section C104 selected by the switching step writes the initialization cell into the memory C101 (cell writing step).

Further, when the write side detecting cell production section C102 is selected, inputting of a clock signal outputted from the asynchronous transfer mode layer side interface apparatus C300 is permitted to write the initialization cell into the memory C101, but when the read side detecting cell production section C104 is selected, part of the read enable flag held in the memory C101 is masked to read out the initialization cell, and the mask of the read enable flag is cancelled to write the initialization cell into the memory C101 (processing step).

In the following, a write procedure and a detection procedure in flows of automatic detection of the UTOPIA function by the ATM layer side interface apparatus C300 and the physical layer side interface apparatus C200 are described.

First, in the physical layer side interface apparatus C200 and the ATM layer side interface apparatus C300, at a point of time when a power-on reset (XRST) state is cancelled, the write side detecting cell production section C102 of the FIFO processing section C100 in the physical layer side interface apparatus C200 writes valid cell data for 2 cells into a particular address of the memory C101.

Then, the write side detecting cell production section C102 inputs the information to the write control section C103 and the read control section C105. In this instance, in both of the write control section C103 and the read control section C105, the cell data for 2 cells is written into the same address.

Further, after a time of 106 clocks of the detection circuit C108 elapses after the power-on reset state is cancelled, the detection circuit C108 in the ATM layer side interface apparatus C300 performs detection. It is to be noted that, at this time, the UTOPIA circuit C107 is in a stopping state, and this stopping state continues until a start signal is outputted from the detection circuit C108. Further, while the detection is being performed, RxEnb and RxAddr outputted to the physical layer side interface apparatus C200 are each selected in accordance with a select signal outputted from the detection circuit C108.

Here, when the detection by the detection circuit C108 comes to an end, the detection circuit C108 transmits physical layer data and a start signal to the UTOPIA circuit C107. The UTOPIA circuit C107 receives the physical layer data and the start signal and thus starts its operation.

Also a select signal outputted from the detection circuit C108 is converted into a signal for selecting RxEnb and RxAddr outputted from the UTOPIA circuit C107, and after the conversion, an ordinary UTOPIA operation is performed. In particular, data of the physical layer side interface apparatus C200 is assembled, and the assembled data is outputted to the higher order layer side.

Accordingly, the cell processing method of the present invention is a cell processing method of the asynchronous transfer mode layer side interface apparatus C300 which uses a UTOPIA interface representative of a signal interface between the physical layer and the asynchronous transfer mode layer in the asynchronous mode. First, the physical layer side interface apparatus C200 writes an initialization cell to be used for detection of physical layer data regarding the UTOPIA interface (writing step).

Then, the asynchronous transfer mode layer side interface apparatus C300 detects physical data regarding the UTOPIA interface from a signal which has a UTOPIA level and a UTOPIA mode (detection step).

Then, the asynchronous transfer mode layer side interface apparatus C300 outputs information data and second address information received by the physical layer side interface apparatus C200 to the higher order layer based on the physical layer data obtained by the detection step (reception cell processing step).

Now, a detection procedure is described.

After the power-on reset state is cancelled, the 53-nary counter C205 starts its free running from its initial value ‘0’ and re-loads the initial value after its count value reaches ‘52’ or when ‘H’ of RxSOC is inputted thereto. The control section C201 stands by for a period of 104 clocks based on the count value inputted from the 53-nary counter C205. In other words, the control section C201 stands by until the count value ‘52’ is inputted twice thereto.

Thereafter, the control section C201 transmits a level-mode inspection request to the level-mode detection section C202 and transmits a Clav inspection request to the physical layer number detection section C204. The reason why the requests are transmitted to the blocks resides in that, when initialization of the write side is performed by the FIFO processing section C100 of the physical layer side interface apparatus C200, data for 2 cells is stored into the memory C101.

The physical layer number detection section C204 receives the Clav inspection request and notifies the control section C201 of which bit or bits of four bits forming RxClav are ‘H’ as an inspection result together with a decision signal in response to the received Clav inspection request.

The control section C201 receives the notification from the physical layer number detection section C204 and cancels the Clav inspection request to the physical layer number detection section C204. Simultaneously, the control section C201 can recognize which bit or bits of RxClav are ‘H’ then from the contents of the notification from the physical layer number detection section C204 and consequently can discriminate which mode the UTOPIA control mode is.

In the following, operation of the control section C201 for discriminating which mode the UTOPIA control mode is described based on the value of RxClav[0] and the values of RxClav[1] to RxClav[3].

First, when only RxClav[0] is ‘H’, RxClav indicates that the number of ports of the physical layer side interface apparatus C200 connected is ‘1’. Accordingly, the control section C201 can discriminate that the UTOPIA control mode is the level 1 operation mode. It is to be noted that the control section C201 cannot make discrimination of the level, bit width and cell length.

Therefore, the unknown points are discriminated from the following operation.

First, the control section C201 sets RxEnb to ‘1’, instructs the physical layer side interface apparatus C200 to start transmission of a cell and keeps RxEnb fixed to this value until a second cell is received. Further, since the physical layer side interface apparatus C200 does not require RxAddr, the control section C201 fixes all RxAddr to ‘1’.

Then, when the control section C201 receives RxSOC of the first cell, it transmits a bit width-cell length inspection request to the bit width-cell length detection section C203. Consequently, the bit width-cell length detection section C203 inspects the bit width and the cell length for a period of time until RxSOC of the second cell is inputted.

After RxSOC of the second cell is inputted, an inspection result representative of a bit width and a cell length is transmitted from the bit width-cell length detection section C203 together with a decision signal to the control section C201. The control section C201 receives the decision signal and then cancels the bit width-cell length inspection request to the bit width-cell length detection section C203.

Meanwhile, the level-mode detection section C202 transmits an inspection result representative of a level and a mode to the control section C201 together with a decision signal. The control section C201 receives the inspection result and the decision signal and cancels the level-mode inspection request to the level-mode detection section C202. At this point of time, no unknown point remains any more, and therefore, the inspection is ended. When the control section C201 completes its reception of the second cell, it sets RxEnb to ‘H’ to stop the data reception.

On the other hand, when any of the second to fourth bits (RxClav[1] to RxClav[3]) of RxClav is ‘H’, the number of bits of RxClav which are ‘H’ indicates the number of connected physical layers.

Consequently, the control section C201 can discriminate that the physical layer side interface apparatus C200 is in a direct mode wherein a plurality of (2 to 4) physical layer side interface apparatus C200 are involved. On the other hand, the control section C201 cannot discriminate a level-bit width and a cell length. Therefore, the unknown points are detected by the following operation.

The control section C201 first conveys ‘0’ with RxAddr[5:0] and then sets RxAddr[5:0] to all ‘1’ and sets RxEnb to ‘L’ in the following clock cycle thereby to request for data transmission from that one of a plurality of physical layers connected which corresponds to the address ‘0’.

Further, the control section C201 fixes RxAddr[5:0] to all ‘1’ and keeps RxEnb fixed to ‘L’ until the second cell is received. When RxSOC of the first cell is received, the control section C201 transmits a bit width-cell length inspection request to the bit width-cell length detection section C203.

Then, the bit width-cell length detection section C203 performs an inspection of the bit width and the cell length for a time until RxSOC of the second cell is inputted thereto. After RxSOC of the second cell is inputted, the control section C201 receives an inspection result representative of a bit width and a cell length transmitted thereto from the bit width-cell length detection section C203 together with a decision signal. Then, the control section C201 cancels the bit width-cell length inspection request to the bit width-cell length detection section C203.

Further, the control section C201 receives an inspection result representative of a level and a mode transmitted thereto from the level-mode detection section C202 together with a decision signal, and cancels the level-mode inspection request to the level-mode detection section C202. The detection is ended at this point of time. Consequently, when reception of the second cell is completed, the control section C201 sets RxEnb to ‘H’ to stop the reception of data (an ATM cell).

On the other hand, if none of RxClav is ‘H’, this represents that a plural number of physical layers are connected and the mode is either a single Clav mode (a mode in which polling is performed with RxClav of one bit) or a multi-Clav mode (a mode in which polling is performed with RxClav of 4 bits).

It is to be noted that, at this point of time, none of the contents of the inspection items are decided, and therefore, the control section C201 uses the following operation to detect all of the contents.

First, the control section C201 sends RxAddr to notify the physical layer side interface apparatus C200 of ‘0’ and outputs a Clav confirmation request to the level-mode detection section C202 simultaneously with the notification.

Then, the control section C201 sends RxAddr to convey all ‘1’ in the next clock cycle and then sends RxAddr to convey ‘0’ in the further next clock cycle. During the second clock cycle, an inspection result representative of a level and a mode is transmitted together with a decision signal from the level-mode detection section C202 to the control section C201.

The control section C201 receives the inspection result and cancels the Clav confirmation request and the level-mode inspection request transmitted to the level-mode detection section C202. Simultaneously, the control section C201 sets RxEnb to ‘0’ and RxAddr to all ‘1’. The control section C201 keeps the value of RxEnb until a second cell is received.

Then, the control section C201 starts polling using a polling method suitable for each level and each mode from the next clock cycle. Here, the control section C201 starts polling first not from the address ‘0’ conveyed to the physical layer side interface apparatus C200 but from the next address. It is to be noted that the next address signifies ‘1’ if RxClav used is composed of 1 bit but signifies ‘4’ if RxClav is composed of 4 bits. Further, the polling continues for the control section C201 by the physical layer number detection section C204. At this point of time, the number of physical layers transmitted from the physical layer number detection section C204 includes some error, and the error is corrected in a stage in which physical layer data is produced.

The ATM layer side interface apparatus C300 receives a cell from the physical layer side interface apparatus (not shown) which corresponds to the address ‘0’ because the control section C201 has set RxEnb to ‘1’. When the control section C201 receives the information that RxSOC representative of the top of a cell has become ‘1’, it transmits a bit width-cell length inspection request to the bit width-cell length detection section C203.

Consequently, the bit width-cell length detection section C204 inspects the bit width and the cell length for a time until RxSOC of the second cell is inputted thereto. Meanwhile, the control section C201 notifies the physical layer number detection section C204 of a physical layer number inspection request and a counting method at the same timing as that of the bit width-cell length inspection request.

The physical layer number detection section C204 starts counting of the number of physical layers in accordance with the physical layer number counting method of the conveyed notification. Further, after RxSOC of the second cell is inputted, an inspection result representative of a bit width and a cell length is transmitted together with a decision signal from the bit width-cell length detection section C203 to the control section C201, and therefore, the control section C201 receives the inspection result. Then, the control section C201 cancels the bit width-cell length inspection request to the bit width-cell length detection section C203.

At this point of time, detection of any other than the number of physical layers is ended. Therefore, the control section C201 sets RxEnb to ‘H’ to stop the reception of data (an ATM cell) after reception of the second cell is completed.

It is to be noted that, as regards counting of the number of physical layers, when the number of physical layers is greater than a particular number, the number of all physical layers cannot sometimes be counted while one cell is received. Therefore, once a physical layer number inspection request is received, the physical layer number detection section C204 continues to count the number of physical layers irrespective of whether or not a cell is received. Then, if the number of physical layer is decided, then the physical layer number detection section C204 notifies the control section C201 of the physical layer number. Upon reception of the notification, the control section C201 corrects the physical layer number and cancels the physical layer number inspection request to the physical layer number detection section C204.

Then, after all information necessary for decision of a mode and a level is collected, the control section C201 outputs the collected information as physical layer data and as setting information to the UTOPIA circuit C107 and simultaneously outputs a start signal to start up the UTOPIA circuit C107.

Further, the control section C201 varies the select signal and outputs a switching instruction to the selector C109 to switch the selected circuit from the detection circuit C108 to the UTOPIA circuit C107.

In the following, the physical layer side interface apparatus C200 and the asynchronous transfer mode layer side interface apparatus C300 described above are described in more detail.

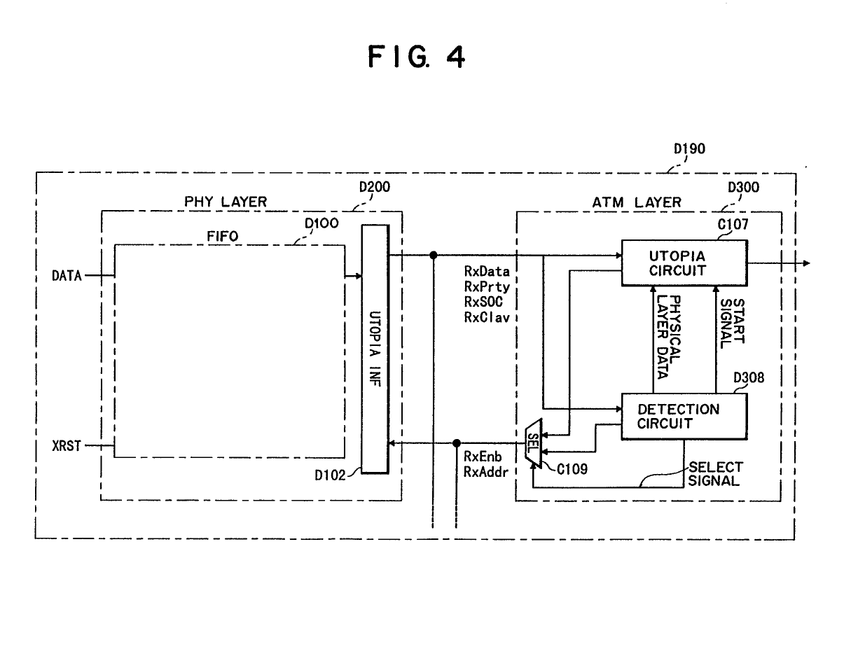

FIG. 4 is a block diagram of an asynchronous transfer mode communication apparatus according to the embodiment of the present invention. Referring to FIG. 4, the asynchronous transfer mode communication apparatus D190 uses a UTOPIA interface representative of a signal interface between the physical layer and the asynchronous transfer mode layer in the asynchronous transfer mode. The asynchronous transfer mode communication apparatus D190 includes a physical layer side interface apparatus D200 for transmitting and receiving a UTOPIA interface signal, and an asynchronous transfer mode layer side interface apparatus D300 for transmitting and receiving a UTOPIA interface signal.

The physical layer side interface apparatus D200 (represented as PHY layer) includes a FIFO processing apparatus D100 and a UTOPIA interface section D102 (represented as UTOPIA INF). The asynchronous transfer mode layer side interface apparatus D300 (represented as ATM layer) includes a detection circuit D308, a UTOPIA circuit C107, and a selector C109. Those of the elements mentioned above which are denoted by like reference characters to those described hereinabove are like elements or elements having like functions, and therefore, overlapping description of them is omitted herein to avoid redundancy.

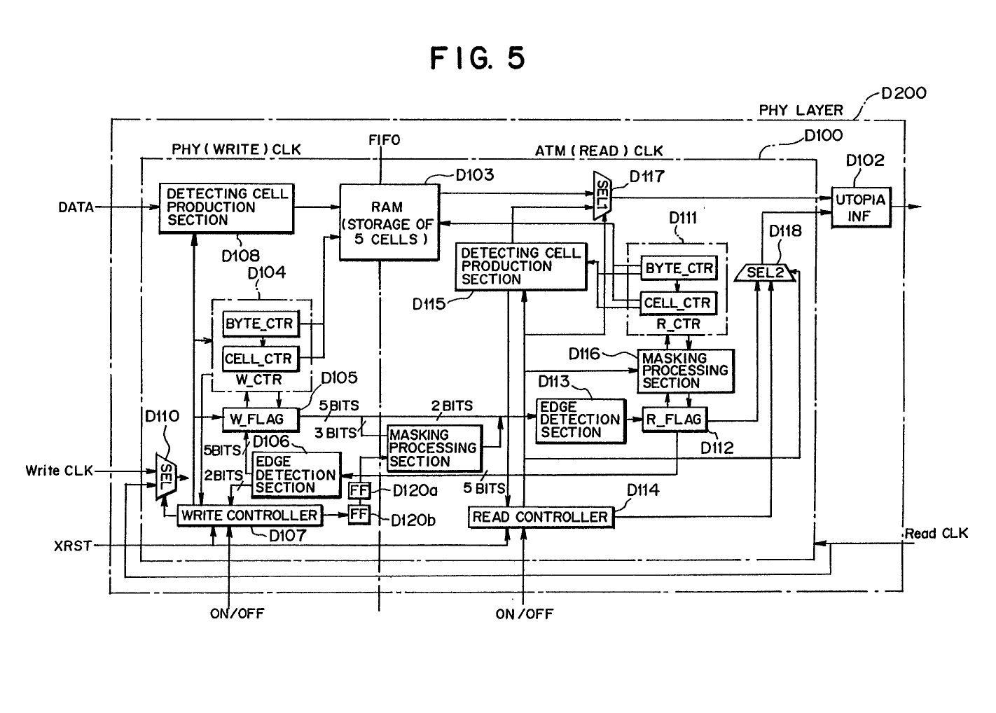

FIG. 5 is a block diagram of the physical layer side interface apparatus D200 according to the embodiment of the present invention. Referring to FIG. 5, the physical layer side interface apparatus D200 shown uses a UTOPIA interface representative of a signal interface between the physical layer and the asynchronous transfer mode layer in the asynchronous transfer mode. The physical layer side interface apparatus D200 includes a FIFO processing section D101 and a UTOPIA interface processing section D102. The FIFO processing section D100 shown in FIG. 5 corresponds to the FIFO processing section C100 described hereinabove.

The FIFO processing section D100 includes a RAM section D103 and further includes, on the write side (left side in FIG. 5) of the RAM section D103, a detecting cell production section D108, a write counter D104 (represented as W_CTR), a write flag outputting section (represented as W_FLAG) D105, an edge detection section D106, a write control section D107 (represented as Write Controller), a selection section (represented as SEL) D110, and a pair of flip-flops (represented as FF) D120a and D120b.

The FIFO processing section D101 further includes, on the read side (right side in FIG. 5) of the RAM section D103, a selector D117, a read counter (represented as R_CTR) D111, a detecting cell production section D115, a read control section (represented as Read Controller) D114, a masking processing section D109, a read flag (represented as R_FLAG) D112, an edge detection section D113, and a selector D118.

Thus, it is selected whether an initial state is set by the write side or the read side, and the setting method for an initial state is varied based on the selection.

The UTOPIA interface processing section D102 corresponds to the UTOPIA interface section C106 (refer to FIG. 1).

The RAM section D103 is capable of holding an initialization cell for detecting physical layer data regarding a UTOPIA interface and functions as holding means. The RAM section D103 is capable of storing five particular ATM cells.

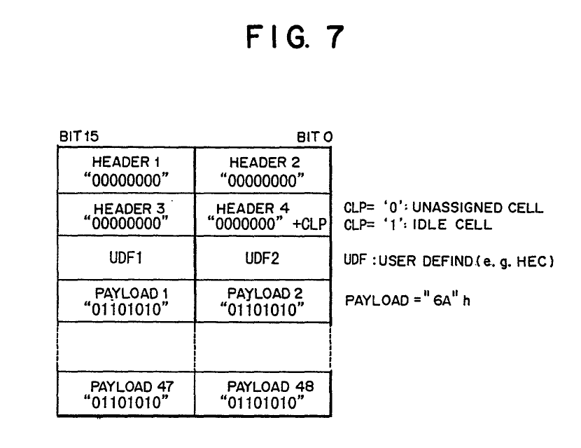

For the particular ATM cells, idle cells/unassigned cells are used. It is to be noted that the particular cells for writing are not limited to ATM cells, but some other cells can be used alternatively. The cell format of the cells is illustrated in FIG. 7.

Now, the blocks of the RAM section D103 on the write side are described. The detecting cell production section D108 is connected to the input side of the RAM section D103 (holding means) and is capable of writing an initialization cell. Thus, the detecting cell production section D108 functions as write side detecting cell production means. Further, the detecting cell production section D108 transmits the particular ATM cells to the write counter D104 after a power-on reset state is cancelled in accordance with an instruction of the write control section D107.

The write counter D104 is provided on the write side and holds the number of times by which writing is performed. The write counter D104 includes a byte counter (represented as Byte_CTR) for counting the number of bytes and a cell counter (represented as Cell_CTR) for counting the number of cells.

The write flag outputting section D105 receives a signal from the edge detection section D106 and writes a write completion flag signal. The edge detection section D106 recognizes that two cells have been read out by the read side. The write control section D107 controls writing into the detecting cell production section D108 and produces an operation instruction of a detection state.

The selection section D110 selects between a write clock signal (Write CLK) and a read clock signal (Read CLK) upon writing of a detecting ATM cell and upon writing of an ordinary ATM cell into the RAM section D103. The flip-flops (represented as FF) D120a and D120b individually hold and output data at a predetermined timing. The masking processing section D109 is provided for the flip-flop 120a so that a masking process is performed for the write completion flag to be outputted from the write flag outputting section D105 to the edge detection section D113.

Now, those blocks which perform setting of an initial state on the read side are described.

First, the selector D117 (represented as SEL1) selects data from the RAM section D103 or data from the detecting cell production section D115 in accordance with an instruction from the read control section D114 and transmits the selected data to the UTOPIA interface section D102.

The read counter D111 is a counter which is provided on the readout side and holds the number of times by which reading is performed. The read counter D111 includes a byte counter (represented as Byte_CTR) for counting the number of bytes and a cell counter (represented as Cell_CTR) for counting the number of cells.

The detecting cell production section D115 is connected to the output side of the RAM section D103 and is capable of writing an initialization cell. The detecting cell production section D115 thus functions as read side detecting cell production means. Further, the detecting cell production section D115 transmits the particular ATM cells to the UTOPIA interface section D102 in accordance with an instruction of the read control section D114. The read control section D114 thus issues an operation instruction of an initial state.

The masking processing section D116 is provided between the read counter D111 and the read flag D112 and performs, while an instruction from the read control section D114 is applied thereto, masking processing for data to be communicated between the read counter D111 and the read flag D112 so that a readout flag outputted from the read flag D112 may not be conveyed. The read flag D112 outputs a signal representative of whether or not a cell is present in the RAM section D103.

The edge detection section D113 detects an edge. The selector D118 (represented as SEL2) selectively outputs a signal representative of whether or not there is a cell to be transmitted to the UTOPIA interface section D102 in accordance with an instruction from the read control section D114. In particular, the selector D118 selects one of a signal outputted from the read flag D112 and another signal outputted from the read control section D114 and outputs the selected signal.

It is to be noted that the functions of the blocks described above are all implemented by hardware and software.

In the blocks, the detecting cell production section D115 outputs an idle cell/unassigned cell in accordance with a read request from the read counter D111, and the masking processing section D116 performs masking processing for a signal to be communicated between the read flag D112 and the read counter D111 for a time until the detection operation signal is cancelled.

In other words, the masking processing section D116 transmits or receives a signal to or from the read counter Dill and the read flag D112 as if two cells were written in the RAM section D103.

Meanwhile, the selector D117 selects data outputted from the detecting cell production section D115 in place of data outputted from the RAM section D103 while the detection operation signal is outputted. The selected data is outputted to the UTOPIA interface section D102. Further, the selector D118 selects data outputted from the read control section D114 in place of data outputted from the read flag D112 while the detection operation signal is outputted. Thus, a signal representative of whether or not a cell is present in the RAM section D103 is outputted to the UTOPIA interface section D102.

The write control section D107 and the read control section D114 cooperate with each other to function as switching means. In particular, the switching means is connected to the detecting cell production section D108 (write side detecting cell production means) and the detecting cell production section D115 (readout side detecting cell production means) and is capable of selectively switching the detecting cell production section D108 and the detecting cell production section D115 so that one of them is write-enabled while the other is write-inhibited.

The initialization method by the switching means is selected by switching setting pins of the write control section D107 and the read control section D114 ON/OFF.

In the following, manners in initialization of the individual components by the switching are described.

First, when initialization is to be performed by the write side, after a power-on reset state is cancelled, the write control section D107 outputs a select signal to the selector D110 so that the clock signal for reading out is selected. The reason of this selection is that it is intended to allow data for two cells, which are to be written into the RAM section D103 first, to be written as fast as possible before 106 clocks are counted and to allow a time schedule of the ATM layer side interface apparatus D300 side to be observed. It is to be noted that the time schedule signifies that the ATM layer side interface apparatus D300 operates with the clock signal.

Simultaneously when the write control section D107 outputs the select signal to the selector D110, the write control section D107 outputs signals to the write counter D104, write flag outputting section D105 and detecting cell production section D108. Consequently, data for two cells is written into the RAM section D103. It is to be noted that writing from the outside is rejected during the writing.

On the other hand, immediately after the power-on reset state is cancelled, because frame synchronization or cell synchronization (HEC synchronization) is required, effective writing of a cell does not take place within such a time within which data for two cells is written.

The write control section D107 issues a notification through the write flag outputting section D105 to mask the high order three cells of a write completion flag signal to the masking processing section D109. Here, while detection by the ATM layer side interface apparatus D300 is proceeding, it is necessary that any other cell than the two cells to be written in first is not written in the RAM section D103 of the FIFO processing section D101. However, practically there is the possibility that some cell may possibly be written in the RAM section D103. Therefore, until after reading in for two cells by the ATM layer side interface apparatus D300 comes to an end, the write control section D107 masks the remaining 3 cells of the write completion flag for a portion of the RAM section D103 into which data is to be written first. Consequently, even if some cell is written into the RAM section D103 in addition to the first two cells, the writing is not conveyed to the read side.

After the detecting cell production section D108 on the write side starts writing into the RAM section D103, the writing of two cells comes to an end in a time of 106 clocks in the maximum (in the 8-bit mode). Then, the notification is transmitted from the write counter D104 to the write control section D107, and at this point of time, the write control section D107 changes the select signal to the selection section D110 to the write clock signal. Simultaneously, the write control section D107 cancels its signal outputting to the write flag outputting section D105 and the detecting cell production section D108 so that the write side may thereafter perform its ordinary operation.

At this time, since the data clock signal is changed (switching of the clock signal), the write control section D107 protects data of a signal to be outputted to the masking processing section D109 through the two flip-flops D120a and D120b. Consequently, an asynchronous signal can be outputted with a desired clock signal, and besides, a meta-staple state can be prevented.

After two cells are written into the RAM section D103, the write control section D107 supervises a read completion flag signal represented by the lower order 2 bits of a signal outputted from the edge detection section D106. Then, if the edge detection section D106 recognizes from the read flag D112 on the read side that two cells have been read out, then the write control section D107 cancels the masking process instruction transmitted to the masking processing section D109 so that all operation of the FIFO processing section D101 may return to its ordinary operation.

On the other hand, when the read side is to perform initialization, after the power-on reset state is cancelled, the read control section D114 outputs detection operation signals to the detecting cell production section D115, masking processing section D116, selector D117 and selector D118 and produces detecting cells. The selector D117 and the selector D118 artificially produce a signal representative of whether or not a cell is present in the RAM section D103 and transmit the signal to the UTOPIA interface section D102.

Then, after reading out of two cells comes to an end, the detecting cell production section D115 outputs a completion notification to the read control section D114. Upon reception of the completion notification, the read control section D114 cancels the detection operation signals and returns operation of the FIFO processing section D101 to its ordinary operation.

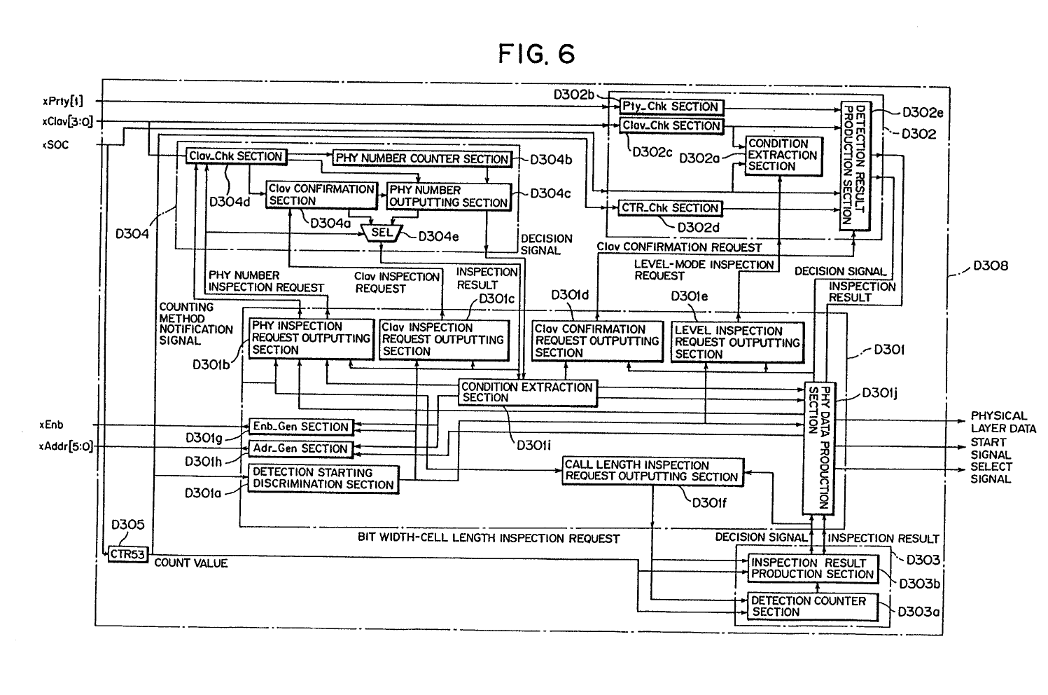

FIG. 6 is a block diagram of the ATM side detection circuit D308 according to the embodiment of the present invention. Referring to FIG. 6, the detection circuit D308 (which may sometimes be referred to as detection circuit D308) includes a level-mode detection section D302 connected to the physical layer side interface apparatus D200 and capable of detecting a level, a mode and a polling method from physical layer data, a physical layer number detection section D304 connected to the physical layer side interface apparatus D200 and capable of detecting the number of connection ports of the physical layer side interface apparatus D200, a bit width-cell length detection section D303 capable of detecting a bit width and a cell length of an interface signal, a control section D301 connected to the level-mode detection section D302 and the physical layer number detection section D304 and capable of outputting data (physical layer data) based on the level, mode and polling method detected by the level-mode detection section D302, a start signal indicating that a cell of the asynchronous transfer mode has been received and a select signal for switching between the detection circuit D308 and the UTOPIA circuit C107, and a 53-nary counter D305 having a counting function.

The control section D301 includes a detection starting discrimination section D301a, a physical layer inspection request outputting section (PHY inspection request outputting section) D301b, a Clav inspection request outputting section D301c, a Clav confirmation request outputting section D301d, a level inspection request outputting section D301e, a cell length inspection request outputting section D301f, an Enb_Gen section D301g, an Adr_Gen section D301h, a condition extraction section D301i, and a physical layer data production section D301j.

The detection starting discrimination section D301a supervises the 53-nary counter D305 to discriminate a timing at which detection is to be started. The physical layer inspection request outputting section D301b outputs a signal for requesting for production of a physical layer number inspection request (PHY number inspection request) The Clav inspection request outputting section D301c outputs a signal for requesting for production of a Clav inspection request.

The Clav confirmation request outputting section D301d outputs a signal for requesting for production of a Clav confirmation request. The level inspection request outputting section D301e outputs a signal for requesting for production of a level inspection request. The cell length inspection request outputting section D301f outputs a signal for requesting for production of a cell length inspection request.

The Enb_Gen section D301g produces RxEnb. The Adr_Gen section D301h produces RxAddr[5:0]. The condition extraction section D301i supervises conditions for determination of operation in the control section D301 and notifies the pertaining blocks in the control section D301 of an operation method.

The condition extraction section D301i further receives a Clav inspection result and a decision signal and extracts the number of those of RxClav which are ‘H’. The physical layer data production section D301j produces physical layer data based on data from the other blocks and produces a start signal for notification of a start of operation to the UTOPIA circuit C107, RxEnb and RxAddr to be transmitted to the physical layer side interface apparatus D200 and a select signal for the selector C109.

It is to be noted that it is determined in accordance with the select signal which one of a signal outputted from the detection circuit D308 and another signal outputted from the UTOPIA circuit C107 is to be selected.

The level-mode detection section D302 shown in FIG. 6 includes a condition extraction section D302a, a Pty_Chk section D302b, a Clav_Chksection D302c, a CTR_Chksection D302d, and a detection result production section D302e.

The condition extraction section D302a performs extraction and discrimination of conditions in accordance with a level-mode inspection request. The Pty_Chk section D302b normally supervises data of RxPrty[1] inputted thereto within two clocks and notifies the detection result production section D302e whether or not the data is ‘0’ within the two clocks. The Clav_Chk section D302c counts the number of ‘1’ of RxClav[3:0] inputted thereto and normally transmits the number to the condition extraction section D302a and the detection result production section D302e.

The CTR_Chk section D302d normally supervises the count value of the 53-nary counter D305 and outputs a marker to the detection result production section D302e only when the count value is within a predefined range (‘25’ to ‘50’). The detection result production section D302e produces an inspection result and a decision signal based on data outputted from the other blocks in the level-mode detection section D302.

The bit width-cell length detection section D303 shown in FIG. 6 includes a detection counter section D303a which normally supervises the count value inputted thereto from the 53-nary counter D305 and counts up for each of predefined values (‘12’, ‘13’, ‘25’, ‘26’, ‘51’, ‘52’), and a detection result production section D303b for producing an inspection result and a decision signal based on a value outputted from the detection counter section D303a.

The physical layer number detection section D304 shown in FIG. 6 includes a Clav confirmation section D304a, a physical layer number counter section (represented as PHY number counter section) D304b, a physical layer number outputting section D304c, a Clav_Chk section D304d, and a selector (represented as SEL) D304e.

The Clav confirmation section D304a produces an inspection result based on data from the Clav_Chk section D304d in accordance with a Clav inspection request from the control section D301. The physical layer number counter section D304b counts up based on the data from the Clav_Chk section D304d. The physical layer number outputting section D304c outputs the count value of the physical layer number counter section D304b as an inspection result of the physical layer number (port number) and produces a decision signal.

The Clav_Chk section D304d outputs a status of Clav based on RxClav[3:0] inputted thereto to the Clav confirmation section D304a, physical layer number counter section D304b and physical layer number outputting section D304c as output destinations. The selector D304e receives a physical layer number inspection request as a select signal and selects which one of data outputted from the Clav confirmation section D304a and data outputted from the physical layer number outputting section D304c should be outputted as an inspection result.

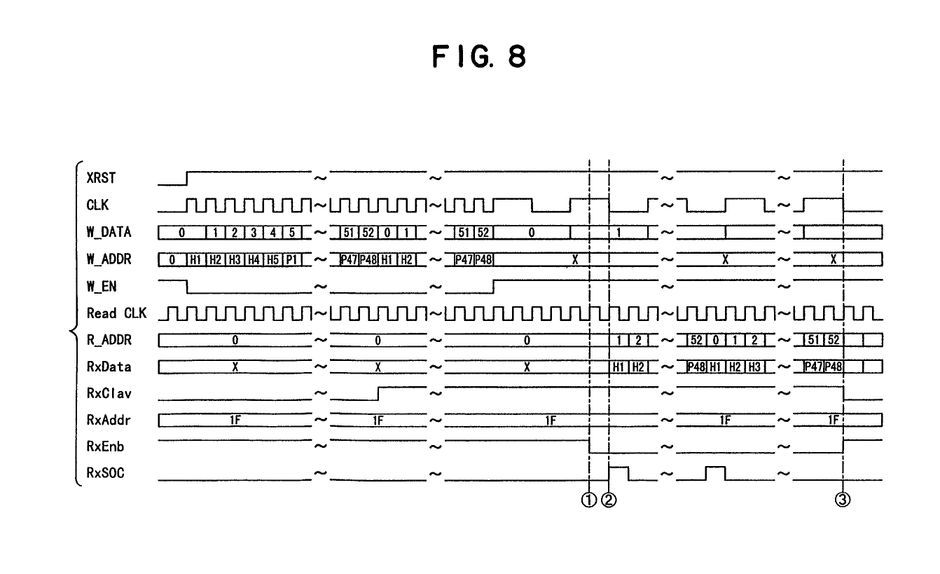

Now, operation of the physical layer side interface apparatus D200 side is described with reference to time charts illustrated in FIGS. 8 to 27. The time charts relate to the operation of the physical layer side interface apparatus D200 when the same level and the same mode are used. Further, each of the time charts illustrates a pattern when initial setting is performed on the write side and another pattern when initial setting is performed on the read side.

It is to be noted that such differences as given in (2-1) and (2-2) below are present among the time charts.

(2-1) Whether idle cells/unassigned cells are written on the write side or are not written on the read side actually into the RAM section D103 within a time of 106 clocks after the power-on reset state is cancelled.

(2-2) That, when initial setting by the write side is selected, variation of a clock signal (exchange of a clock signal) occurs.

Then, signaling of a cell to the detection circuit D308 is performed at the quite same timing. Therefore, in the following description of the time charts, description of both of them is given collectively.

Further, the following signals are illustrated in the time charts. In particular, XRST is a power-on reset signal, CLK a clock signal, W_DATA write data, W_ADDR a write address, and W_EN is a write enable signal. Further, Read CLK is a read clock, R_ADDR a read address, and RxData is data read out. Further, any signal in the time charts indicates ‘H’ on the upper side and ‘L’ on the lower side.

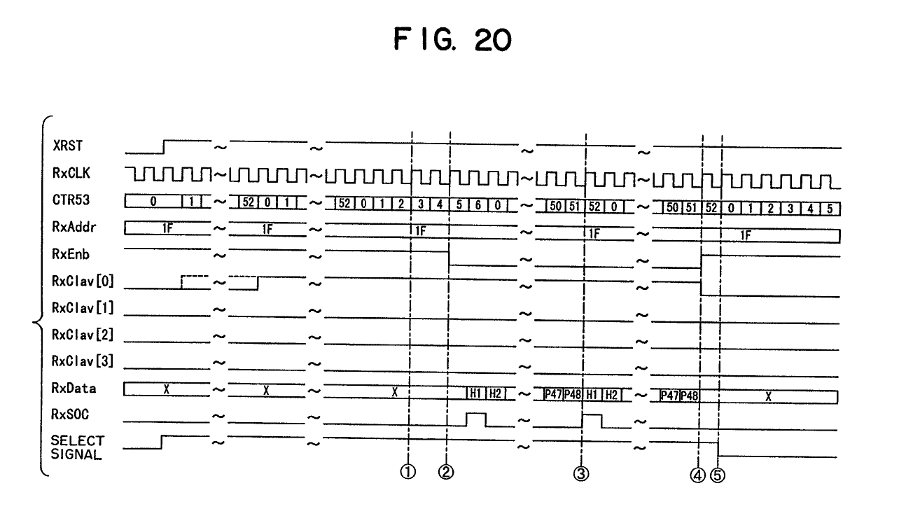

In addition, as described hereinabove, RxClav is a cell reception allowance signal and has three different states. RxAddr is a reception address signal and is used to poll and select a predetermined one of the ATM layer interface apparatus 100. RxEnb is a signal indicating that reception is enabled. RxSOC is a signal representative of the top octet of an ATM cell. Further, “SELECT signal” appearing in FIGS. 20 to 27 indicates a select signal.

The time charts further indicate points of time denoted by \mathring{1} to \mathring{4}, and in the following description, also comparison at the points of time is performed. It is to be noted that the time point \mathring{1} may be sometimes referred to merely as \mathring{1}.

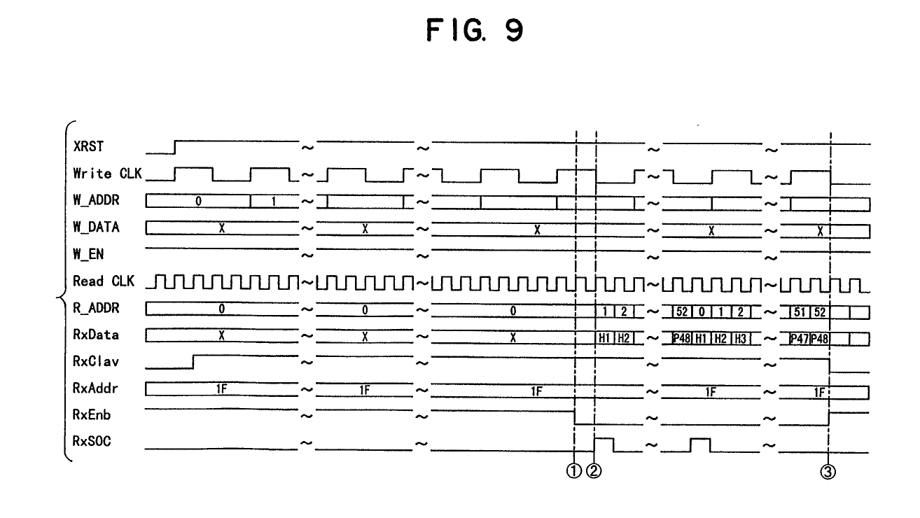

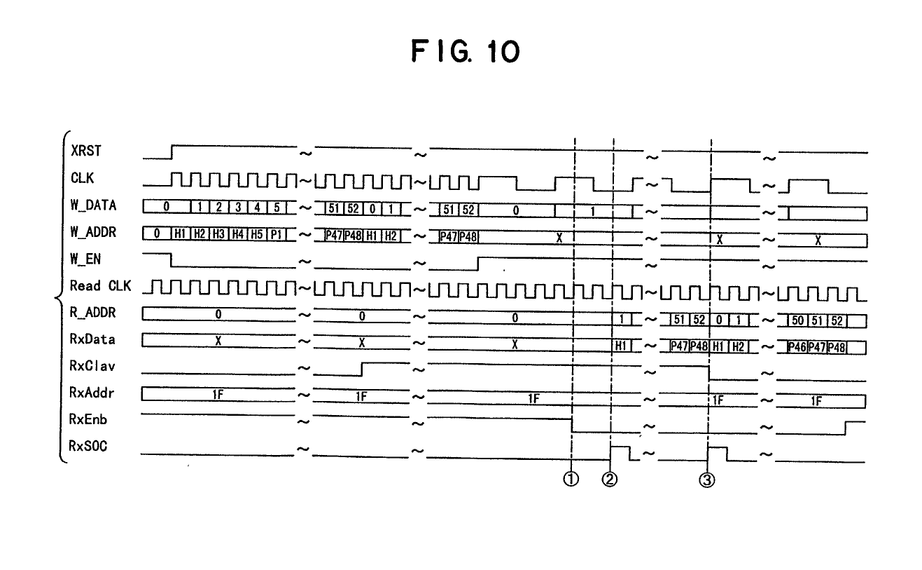

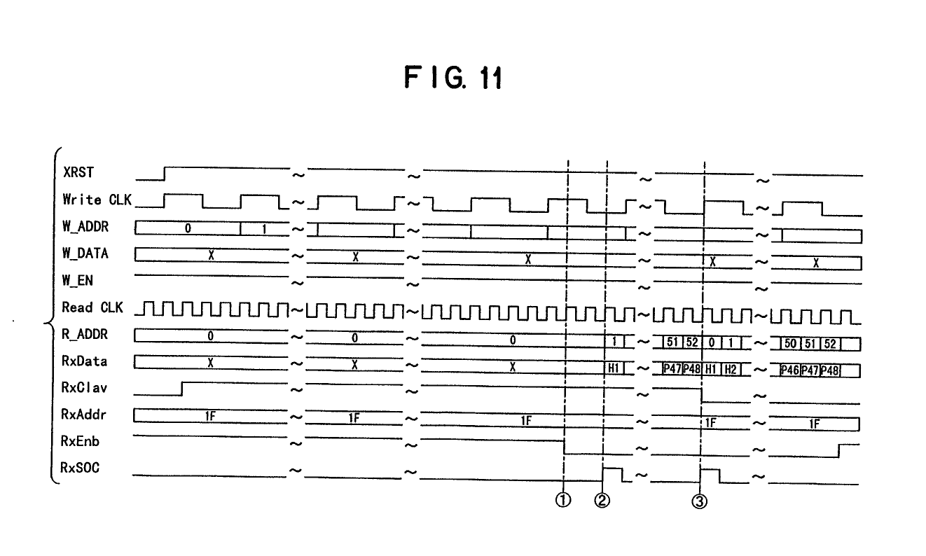

FIG. 8 is a time chart of the physical layer side when initial setting is selected by the write side in the level 1 operation mode of the level 1 and the level 2. FIG. 9 is a time chart of the physical layer side when initial setting is selected by the read side. FIG. 10 is a time chart of the physical layer side when initial setting is selected by the write side. FIG. 11 is a time chart of the physical layer side when initial setting is selected by the read side in the level 1 operation mode of the level 3.

At \mathring{1} of FIG. 8, a time of 106 clocks elapses after the power-on reset state is cancelled, and the detection circuit D308 begins to operate. Accordingly, RxEnb=‘L’ is established, and consequently, the physical layer side starts outputting of a cell in accordance with each level from \mathring{2} of FIG. 8. When the current level is the level 1 or the level 2, RxClav is changed to ‘L’ and outputted simultaneously when transmission of the second cell from \mathring{3} of FIG. 8 is ended.

It is to be noted that also the time chart shown in FIG. 9 is substantially similar to that shown in FIG. 8. Further, also the time charts shown in FIGS. 10 and 11 are substantially similar to that shown in FIG. 8, but are different in that, at \mathring{3} of FIG. 10 and \mathring{3} of FIG. 11, in the level 3, RxClav is changed to ‘0’ and outputted simultaneously when transmission of the first cell is ended.

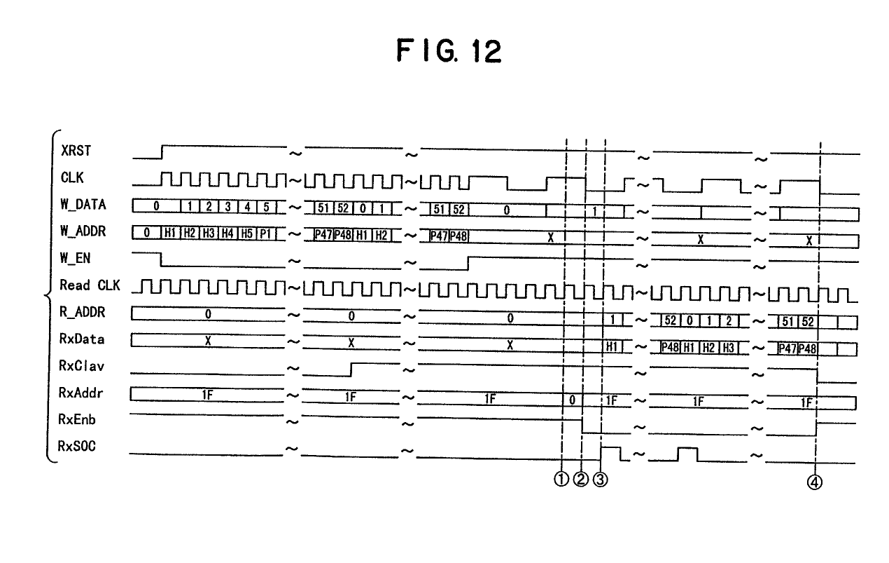

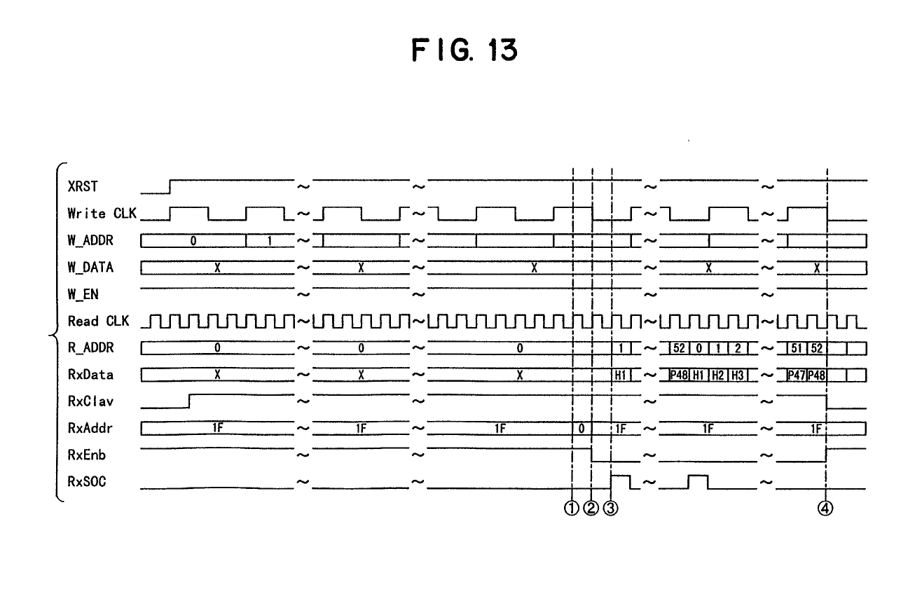

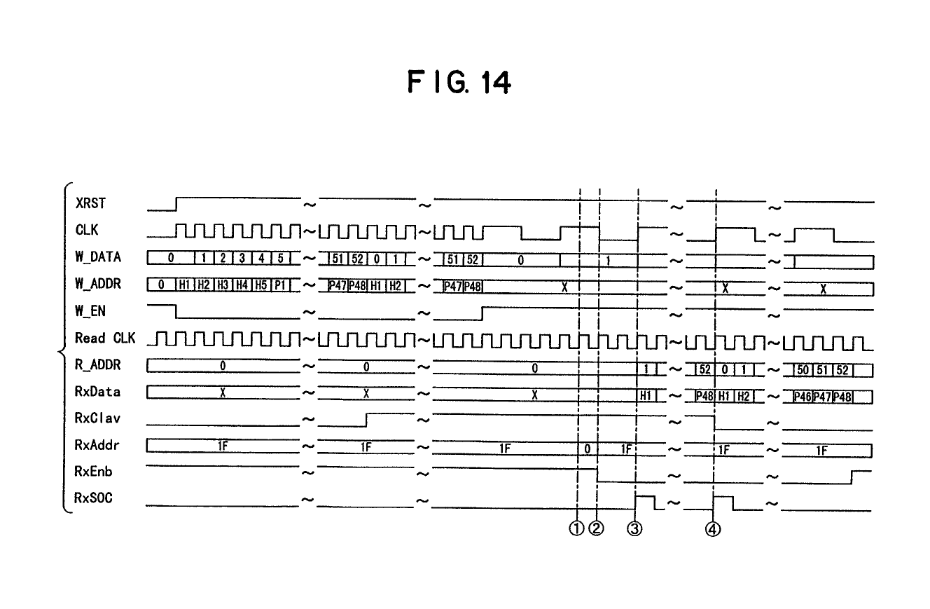

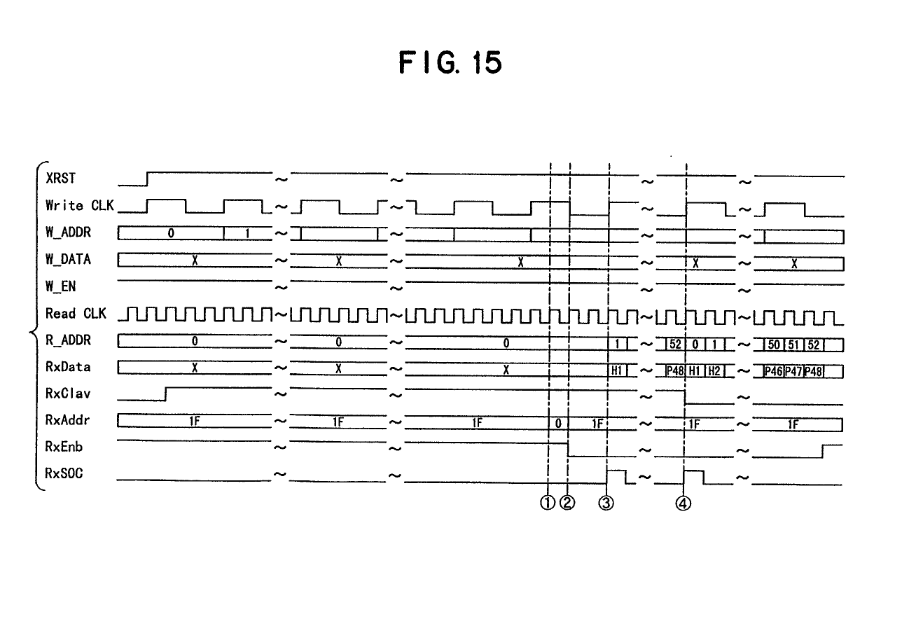

FIG. 12 is a time chart of the physical layer side when an initial setting is selected by the write side in the direct mode of the level 2. FIG. 13 is a time chart of the physical layer side when initial setting is selected by the read side in the direct mode of the level 2. FIG. 14 is a time chart of the physical layer side when initial setting is selected by the write side in the direct mode of the level 3. FIG. 15 is a time chart of the physical layer side when initial setting is selected by the read side in the direct mode of the level 3. Here, the address of the physical layer side corresponds to RxAddr=‘0’.

\mathring{1} shown in FIG. 12 indicates a point of time at which a time of 106 clocks elapses after the power-on reset state is cancelled. Here, if the detection circuit D308 begins to operate, then RxAddr is changed from ‘1F’ to ‘0’. Consequently, the physical layer side recognizes that the address of the physical layer side itself has been conveyed.

Then, RxEnb=‘0’ is established in the next clock cycle (\mathring{2} indicated in FIG. 12). Therefore, the physical layer side starts outputting of a cell in accordance with each level from \mathring{3} of FIG. 12. On the other hand, when the current level is the level 2, RxClav is changed to RxClav=‘0’ and outputted simultaneously when the transmission of the second cell is ended as at \mathring{4} of FIG. 12.

It is to be noted that also the time chart shown in FIG. 13 is substantially similar to that shown in FIG. 12. Further, also the time charts shown in FIGS. 14 and 15 are substantially similar to that shown in FIG. 13. They are different in that, at \mathring{4} of FIG. 14 and \mathring{4} of FIG. 15, the direct mode of the level 3 is different from the direct mode of the level 2, and simultaneously when transmission of the first cell is ended, RxClav is changed to ‘0’ and outputted.

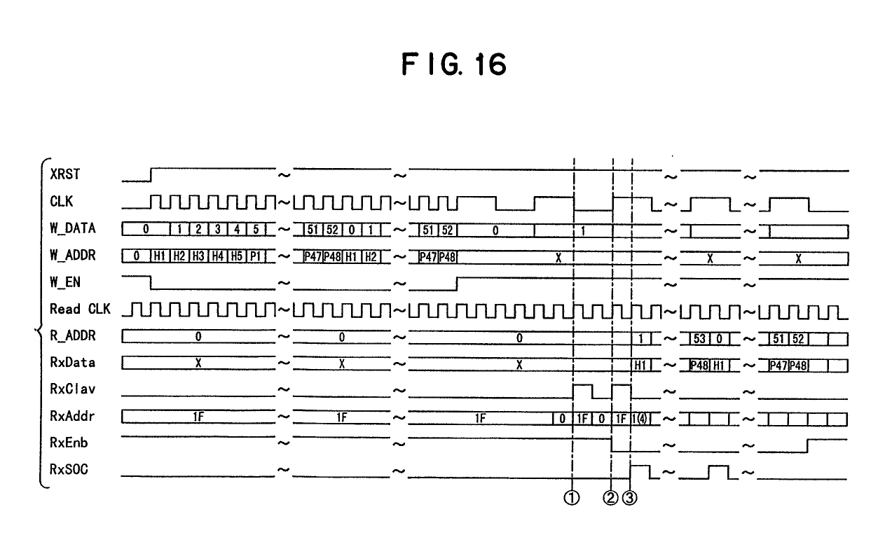

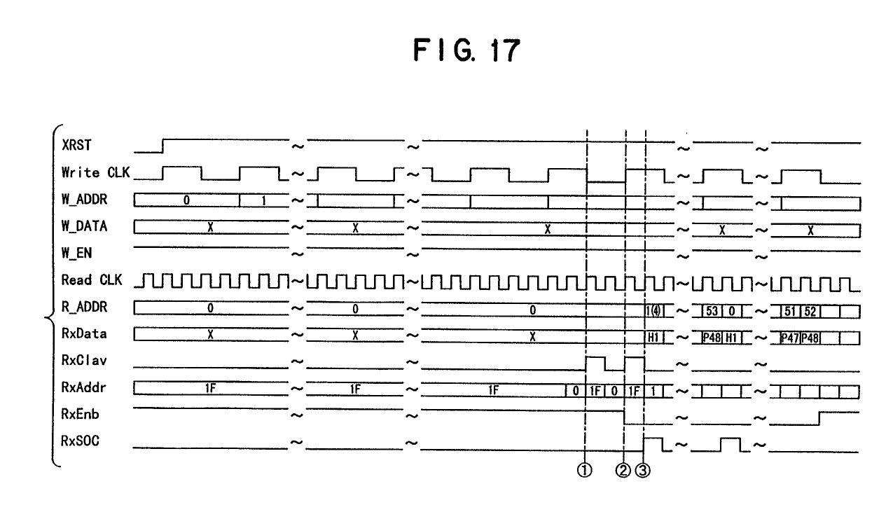

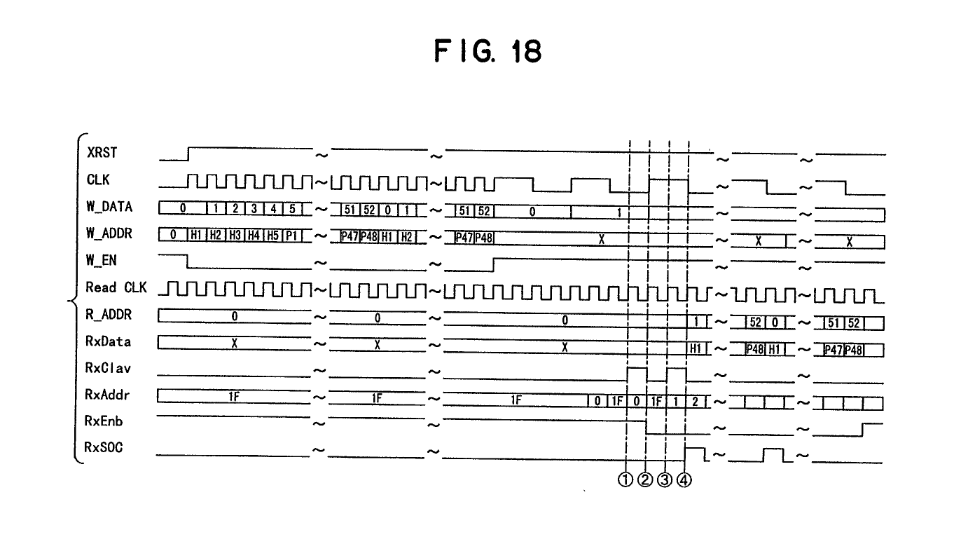

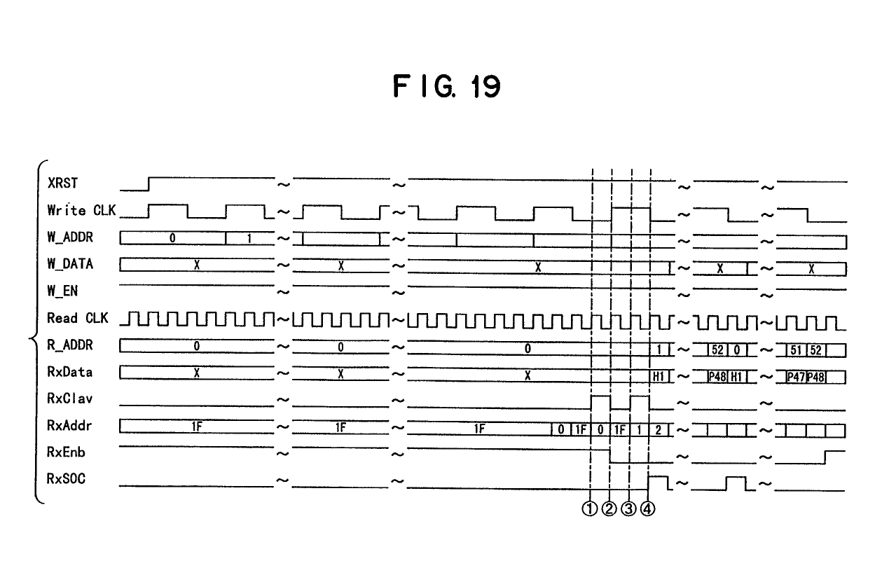

FIG. 16 is a time chart of the physical layer side when initial setting is selected by the write side in the single Clav mode and the multi-Clav mode of the level 2. FIG. 17 is a time chart of the physical layer side when initial setting is selected by the read side in the single Clav mode and the multi-Clav mode of the level 2. FIG. 18 is a time chart of the physical layer side when initial setting is selected by the write side in the single Clav mode of the level 3. FIG. 19 is a time chart of the physical layer side when initial setting is selected by the read side in the single Clav mode of the level 3. The address of the physical layer side corresponds to RxAddr=‘0’.

First, when a time of 106 clocks elapses and the detection circuit detection circuit D308 begins to operate after the power-on reset state is cancelled at the points of time indicated by \mathring{1}, \mathring{2} of FIG. 16, \mathring{1}, \mathring{2} of FIG. 17, \mathring{1}, \mathring{3} of FIG. 18, and \mathring{1}, \mathring{3} of FIG. 19, the address is conveyed in order of ‘0’→‘1F’→‘0’→‘1F’ using RxAddr. Accordingly, the physical layer side interface apparatus D200 having the address ‘0’ notifies the detection circuit D308 of a state of the physical layer side interface apparatus D200 itself using RxClav.

Then, at the next clock (each time point \mathring{2} in FIGS. 16 to 19) at which RxAddr indicated in FIGS. 16 to 19 becomes ‘0’ for the second time, RxEnb is changed to RxEnb=‘0’. Accordingly, the physical layer side interface apparatus D200 starts outputting (RxData) of a cell in accordance with each level from \mathring{3} of FIG. 16, \mathring{3} of FIG. 17, \mathring{4} of FIG. 18 and \mathring{4} of FIG. 19.

Now, operation of the detection circuit D308 is described with reference to FIGS. 20 to 27. FIG. 20 is a time chart of the detection circuit D308 in the level 1 operation mode in the level 1 and the level 2 (8 bits) The time charts of FIGS. 20 to 24 illustrate operation where the physical layer side interface apparatus D200 selects initial setting on the read side. Further, RxClav in FIGS. 20 to 24 are initially indefinite as seen from broken lines.

\mathring{1} of FIG. 20 indicates a point of time at which a time of 106 clocks elapses after the power-on reset state is cancelled, and the detection circuit D308 begins to operate. At the point of time of \mathring{1} at which CTR53=‘3’, RxClav is detected, and it is discriminated from RxClav that the current operation mode is the level 1 operation mode. Further, at the point of time of \mathring{2} of FIG. 20 at which CTR53=‘5’, RxEnb=‘L’ is outputted. Meanwhile, RxAddr is kept fixed to RxAddr=‘1F’.

After the next one clock, two cells are successively transmitted from the physical layer to the detection circuit D308. Since RxClav[0]=‘H’ and CTR53=‘52’ when RxSOC of the second cell is inputted, it can be recognized that the current level is the level 1 or the level 2 with the bit width of 8 (cell length 53). Then, when reception of the two cells comes to an end at \mathring{4} of FIG. 20, RxEnb is changed to RxEnb=‘H’, and the SELECT signal is changed to ‘L’ at \mathring{5} of FIG. 20 to switch the selector so that a signal of the UTOPIA circuit C107 may be selected.

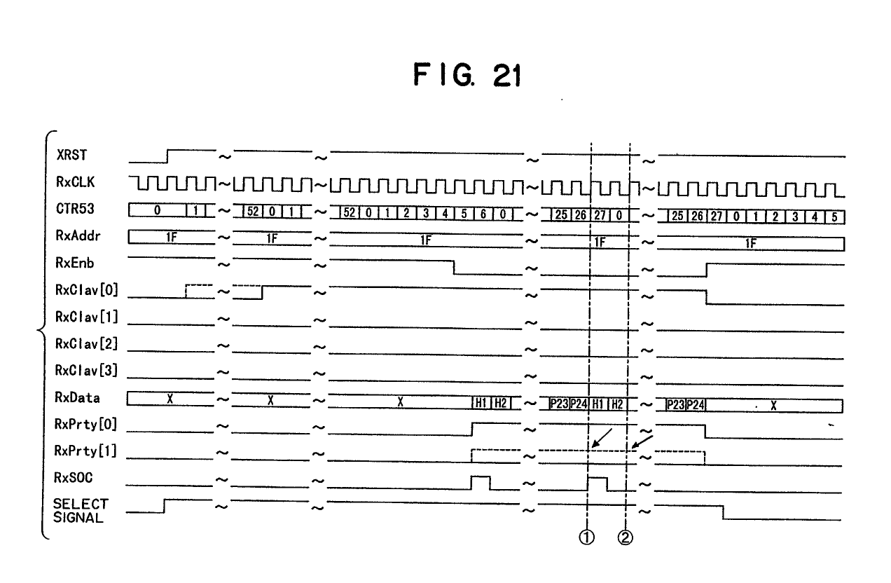

FIG. 21 is a time chart of the detection circuit D308 in the level 1 operation mode of the level 1 and the level 2 (16 bits). The time chart shown in FIG. 21 is different from the time chart shown in FIG. 20 in that, at \mathring{1} of FIG. 21, RxClav[0]=‘1’ and CTR53=‘27’. Accordingly, it can be discriminated that the current level is the level 1 or the level 2 and the bit width is 16 bits.

Further, at the two time points of \mathring{1} and \mathring{2} of FIG. 21 indicated by an arrow mark, RxPrty[1] is superposed at two successive clocks to discriminate whether the current level is the level 1 or the level 2. Here, if RxPrty[1] is ‘0’ at both of the places (indicated by a solid line), then it is discriminated that the current level is the level 2, but if RxPrty[1] is not ‘0’ at any of the places, then it is discriminated that the current level is the level 1. It is to be noted that the remaining part of the detection procedure is the same as that described above.

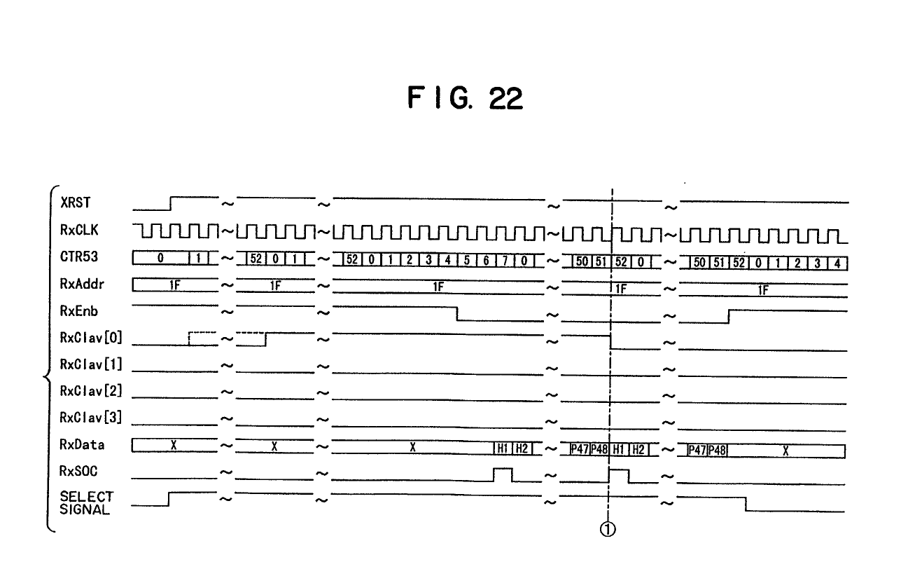

FIG. 22 is a time chart of the detection circuit D308 in the level 1 operation mode of the level 3. The time chart shown in FIG. 22 is different from the time chart shown in FIG. 20 in contents of detection in that, at \mathring{1} of FIG. 22, RxClav[0]=‘L’ and it can be discriminated that the current level is the level 3. It is to be noted that the remaining part of the detection procedure is the same as that described above.

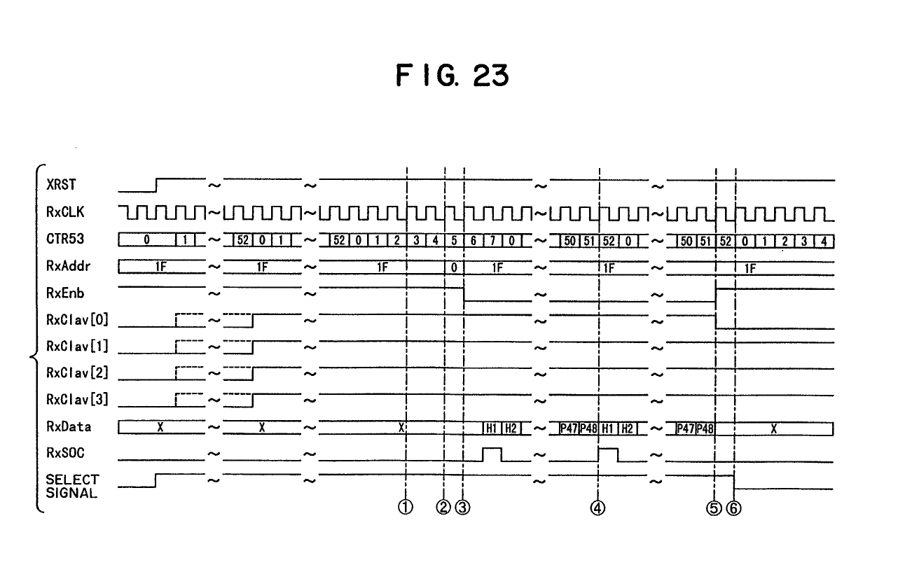

FIG. 23 is a time chart of the detection circuit D308 in the direct mode of the level 2. First, when a time of 106 clocks elapses after the power-on reset state is cancelled, a detection operation is started.

At \mathring{1} of FIG. 23, it is discriminated through detection of RxClav at CTR53=‘3’ that the current mode is the direct mode where the number of physical layers is 4. Then at \mathring{2} of FIG. 23 at which CTR53=‘5’, RxAddr=‘0’ is outputted, and at the next clock (\mathring{3} of FIG. 23), RxEnb changes to RxEnb=‘L’ and RxAddr=‘1F’ is outputted. Consequently, two cells are successively transmitted from the physical layer which corresponds to the address ‘0’ after one clock passes.

Then at \mathring{4} of FIG. 23 at which RxSOC of the second cell is inputted, RxClav=‘H’ and CTR53=‘53’, and therefore, it can be recognized that the bit width is 8 bits (cell length 53) and the current level is the level 2. Further, when reception of the two cells comes to an end at \mathring{5} of FIG. 23, RxEnb is changed to RxEnb=‘H’, and at \mathring{6} of FIG. 23, the select signal is changed to ‘L’ to switch the selector so that a signal of the UTOPIA circuit C107 is selected.

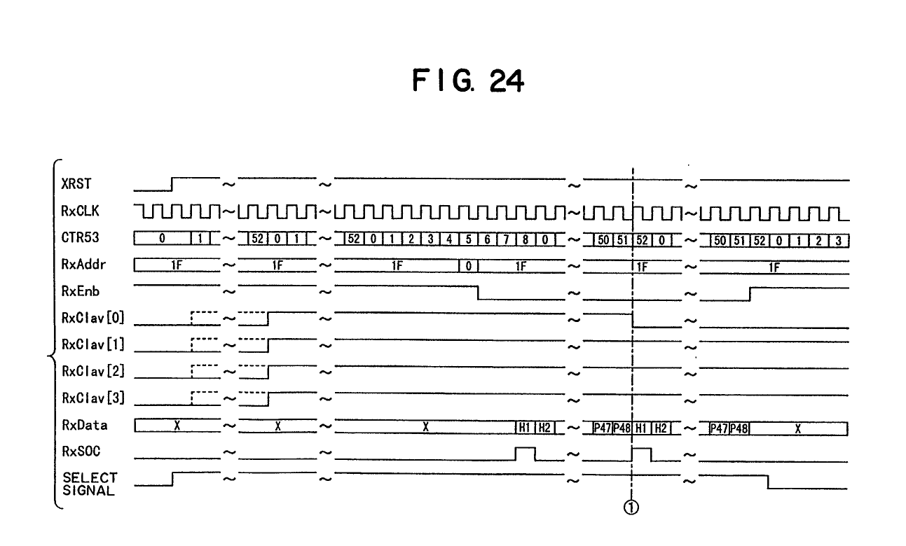

FIG. 24 is a time chart of the detection circuit D308 in the direct mode of the level 3. The time chart shown in FIG. 24 is different from the time chart shown in FIG. 23 in contents of detection in that, at \mathring{1} of FIG. 23, RxClav[0=‘L’ and therefore it is detected that the current level is the level 3. It is to be noted that the remaining part of the detection procedure is the same as that described above.

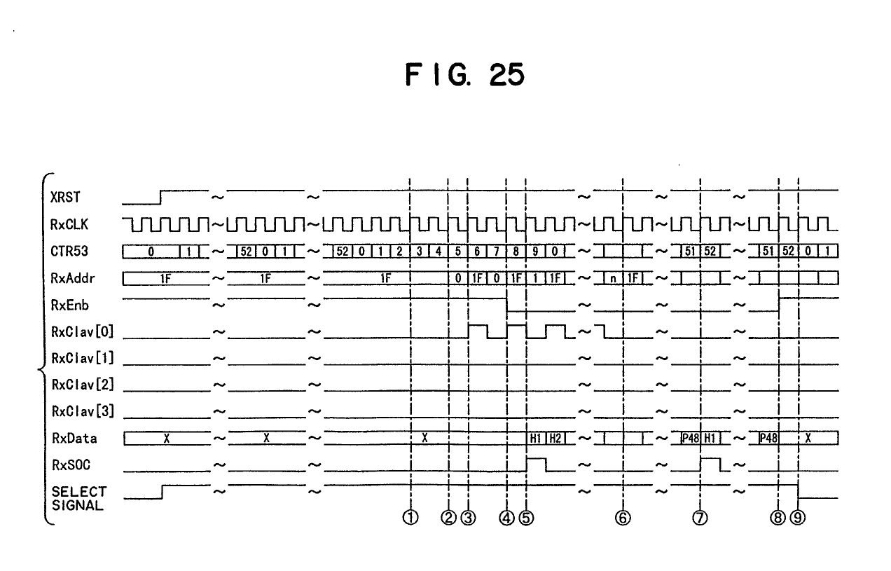

FIG. 25 is a time chart of the detection circuit D308 in the single Clav mode of the level 2. First, when a time of 106 clocks elapses after the power-on reset state is cancelled, a detection operation is started. Then at \mathring{1} of FIG. 25, RxClav at CTR53=‘3’ is detected, and it is discriminated that the physical layer number is a plural number and the current mode is the single Clav mode or the multi-Clav mode. It is to be noted that a plural number of physical layers signifies a plural number of physical layer signals or a plural number of ports of a physical layer side interface apparatus.

Consequently, at \mathring{2} of FIG. 25 at which CTR53=‘5’, RxAddr=‘0’ is outputted, and at the next clock (\mathring{3} of FIG. 25), it is detected that only RxClav[0] is ‘H’. Consequently, it is discriminated that the current mode is the single Clav mode of the level 2. Further, RxAddr outputs ‘0’ at \mathring{5} of FIG. 25 and thereafter outputs ‘1F’, ‘0’, ‘1F’ in order, whereafter polling is started. The polling assumes a form wherein ‘1F’ is outputted between valid addresses because the current mode is the single Clav mode of the level 2. Further, at \mathring{4} of FIG. 25, RxAddr outputs RxAddr=‘0’ for the second time so that reception of a cell from the physical layer which corresponds to the address ‘0’ is started. At \mathring{7} of FIG. 25 at which RxSOC of the second cell is inputted, since CTR53=‘52’, it is discriminated that the bit width is 8 bits (cell length 53). Then, when the reception of two cells comes to an end at \mathring{8} of FIG. 25, RxEnb is changed to RxEnb=‘H’.

Since it is known at \mathring{6} of FIG. 25 that the number of physical layers is n+1, at \mathring{9} of FIG. 25, the selector signal is changed to ‘L’ to perform switching of the selection so that a signal of the UTOPIA circuit C107 is selected.

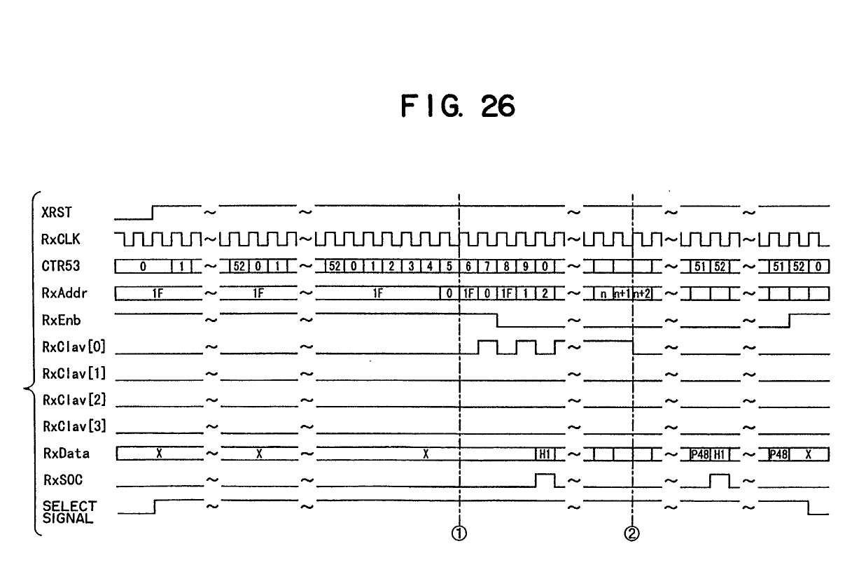

FIG. 26 is a time chart of the detection circuit D308 in the single Clav mode of the level 3. The time chart shown in FIG. 26 is different in contents of detection from the time chart shown in FIG. 25 that, at \mathring{1} of FIG. 26, RxClav[0]=‘L’ and consequently it is detected that the current level is the level 3. Meanwhile, polling assumes a form wherein valid addresses are outputted successively, difference from that in the single Clav mode of the level 2. Therefore, after polling is started, at \mathring{2} of FIG. 26 at which RxClav[0]=‘L’ is detected, counting of the number of physical layers is stopped. It is to be noted that the number of physical layers in this instance is n+1. Further, the remaining part of the detection procedure is the same as that described above.

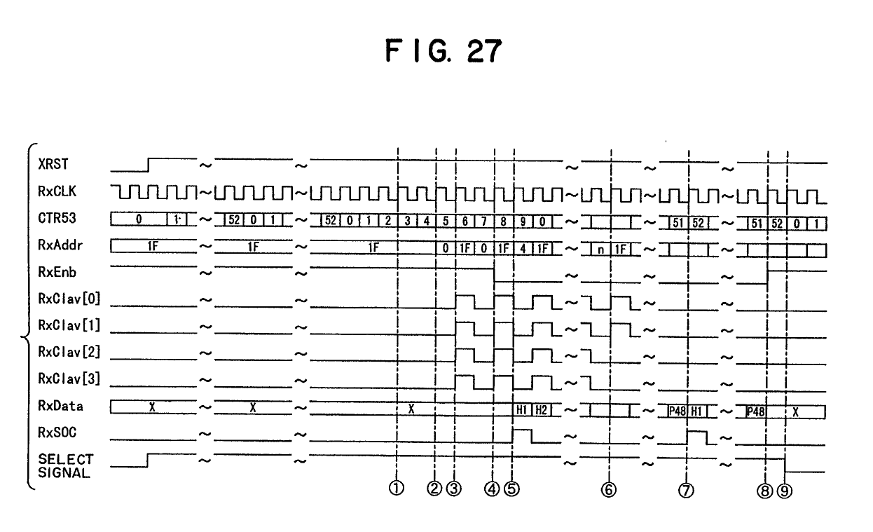

FIG. 27 is a time chart of the detection circuit D308 in the multi-Clav mode of the level 2. First, when a time of 106 clocks elapses after the power-on reset state is cancelled, a detection operation is started. Then at \mathring{1} of FIG. 27, RxClav at CTR53=‘3’ is detected, and it is discriminated that the physical layer number is a plural number and the mode is the single Clav mode or the multi-Clav mode.

Consequently, at \mathring{2} of FIG. 27 at which CTR53=‘53’, RxAddr=‘0’ is outputted, and in the next clock cycle \mathring{3} of FIG. 27), it is detected that all of RxClav[3:0] are ‘H’. Consequently, it is discriminated that the current mode is the multi-Clav mode of the level 2.

Further, after RxAddr outputs ‘0’, it outputs ‘1F’, ‘0’, ‘1F’ in order. Then, polling is started after \mathring{5} of FIG. 27. Then, RxAddr outputs RxAddr=‘0’ for the second time, and in the next cycle (\mathring{4} of FIG. 27), RxEnb=‘1’ is outputted to start reception of a cell from the physical layer which corresponds to the address ‘0’.

Further, since CTR53=‘52’ when RxSOC of the second cell is inputted at \mathring{7} of FIG. 27, it is discriminated that the bit width is 8 bits (cell length 53). Then, when the reception of two cells comes to an end, RxEnb is changed to RxEnb=‘1’ at \mathring{8}. Further, since it is discriminated at \mathring{6} of FIG. 27 that the number of physical layers is n+2, the select signal is changed to ‘0’ at \mathring{9} of FIG. 27 to switch the selector so that a signal of the UTOPIA circuit C107 may be selected.

In this manner, common processing which does not rely upon the level or the mode of a cell used by the physical layer side interface apparatus D200, the bit width in the same mode, the parity addition method depending upon the level or the operation mode is permitted.

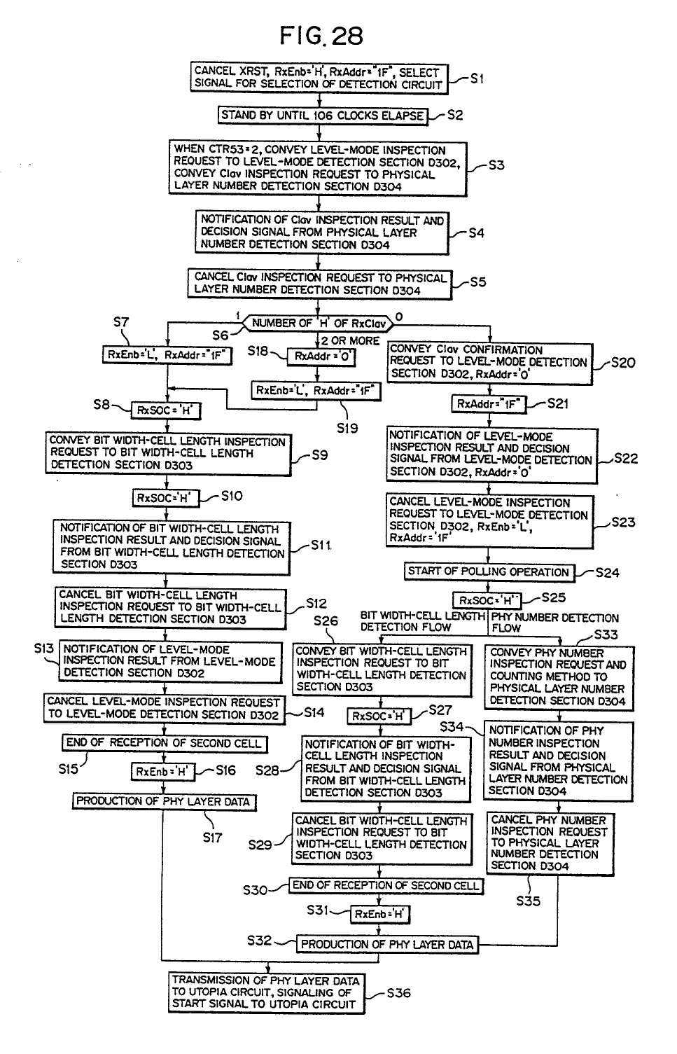

Operation of the blocks of the detection circuit D308 having such a construction as described above is described in detail with reference FIGS. 28 to 32.

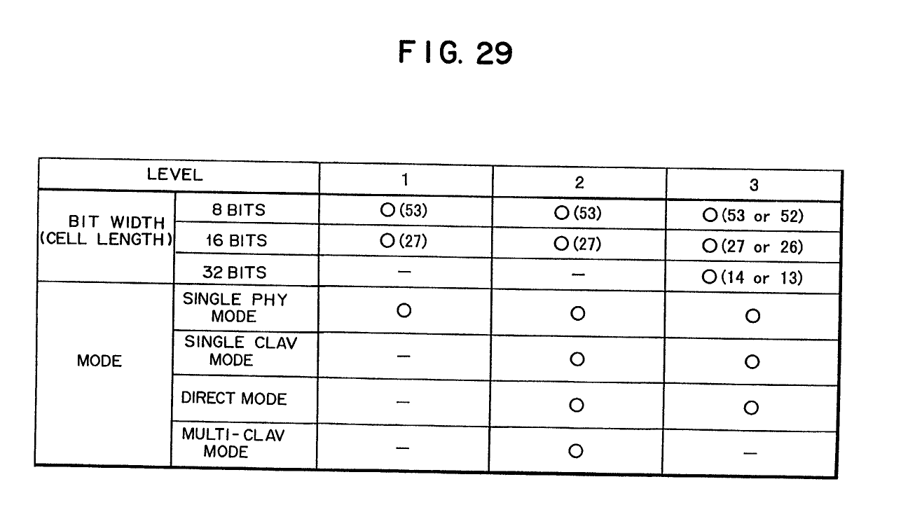

FIG. 28 is a flow chart illustrating operation of the control section D301, and FIG. 29 is a view illustrating data for use upon discrimination of the control section D301. First, in step S1 illustrated in FIG. 28, after the power-on reset state is cancelled, the Enb_Gen section D301g outputs RxEnb=‘H’ while the Adr_Gen section D301h outputs RxAddr=‘1F’ and the physical layer data production section D301j outputs a select signal for detection circuit selection.

In this state, the individual blocks stand by in step S2 until a time of 106 clocks elapses. The detection starting discrimination section D301a supervises the standby time and discriminates that a time of 106 clocks has elapsed at a point of time when ‘52’ as the count value of the 53-nary counter D305 which is running freely is inputted twice.

During the supervision, the outputs to the Clav inspection request outputting section D301c and the level inspection request outputting section D301e are fixed to ‘0’, and after the standby time comes to an end, the count value is outputted as it is.

In step S3, when the count value is ‘2’ after the standby time comes to an end, the Clav inspection request outputting section D301c notifies the physical layer number detection section D304 of a Clav inspection request, and the level inspection request outputting section D301e notifies the level-mode detection section D302 of a level-mode inspection request.

In step S4, the control section D301 receives a Clav inspection result transmitted from the physical layer number detection section D304 together with a decision signal. Then in step S5, the Clav inspection request outputting section D301c having received the decision signal cancels the Clav inspection request to the physical layer number detection section D304, and the condition extraction section D301i having received the Clav inspection result and the decision signal recognizes the number of ‘H’ of RxClav. Further, the Clav inspection request outputting section D301c notifies the Enb_Gen section D301g, Adr_Gen section D301h, physical layer inspection request outputting section D301b, Clav confirmation request outputting section D301d and physical layer data production section D301j of later operations.

Now, operation when the number of ‘H’ of RxClav is 0, 1 and 2 or more in step S6 is described.

First, when the number of RxClav=‘H’ is 1, the Enb_Gen section D301g sets RxEnb to RxEnb=‘L’ and sets RxAddr to RxAddr=‘1F’ and fixes them to the respective values (step S7). Here, a cell is transmitted from the physical layer side, and RxSOH=‘H’ is inputted at the top of the cell (step S8). Further, the cell length inspection request outputting section D301f which recognizes RxSOC=‘H’ outputs a bit width-cell length inspection request to the bit width-cell length detection section D303 (step S9).

Then, after RxSOH=‘H’ of the second cell is inputted (step S10), a bit width and cell length inspection result is conveyed together with a decision signal from the bit width-cell length detection section D303 (step S11). The cell length inspection request outputting section D301f receives the decision signal and cancels the bit width-cell length inspection request (step S12). Meanwhile, the physical layer data production section D301j receives the inspection result and the decision signal and stores the inspection result.

The control section D301 is notified of a level-mode inspection result together with a decision signal from the level-mode detection section D302 (step S13). The level inspection request outputting section D301e receives the decision signal and cancels the level-mode inspection request to the level-mode detection section D302 (step S14). Meanwhile, the physical layer data production section D301j receives the inspection result and the decision signal and stores the inspection result.

Further, when the reception of the second cell comes to an end (step S15), the Enb_Gen section D301g sets RxEnb to RxEnb=‘H’ (step S16), and the physical layer data production section D301j produces physical layer data (PHY layer data) based on the inspection result which holds the physical layer data (step S17).

On the other hand, when the number of RxClav=‘H’ is two or more in step S6, the Adr_Gen section D301h outputs RxAddr=‘0’ (step S18) and then outputs RxAddr=‘1F’ in the next clock cycle and fixes RxAddr to this value. Meanwhile, the Enb_Gen section D301g outputs RxEnb=‘L’ in a clock cycle next to the clock cycle in which RxAddr=‘0’ is outputted, and fixes RxEnb to this value (step S19).

Operation after RxSOH=‘H’ is inputted is the same as that where the number of RxClav=‘H’ is 1, and therefore, overlapping description of it is omitted herein.

On the other hand, when the number of RxClav=‘H’ is ‘0’ in step S6, the Clav confirmation request outputting section D301d receives the notification from the condition extraction section D301i and outputs a Clav confirmation request to the level-mode detection section D302. Simultaneously, the Adr_Gen section D301h outputs RxAddr=‘0’ (step S20) and the Adr_Gen section D301h outputs RxAddr=‘1F’ in the next clock cycle (step S21). Further in step S22, the Adr_Gen section D301h outputs RxAddr=‘0’ at the further next clock. At this time, a level-mode inspection result is conveyed together with a decision signal from the level-mode detection section D302.

The level inspection request outputting section D301e receives the confirmation request and cancels the level-mode inspection request (step S23). The physical layer data production section D301j receives the inspection result and the decision signal and stores the inspection result. Further, the physical layer data production section D301j notifies the Adr_Gen section D301h of a production order of RxAddr and notifies the physical layer inspection request outputting section D301b of a counting method. At this time, the Adr_Gen section D301h outputs RxAddr=‘1F’, and the Enb_Gen section D301g outputs RxEnb=‘L’. RxEnb keeps this value.

In step S24, the Adr_Gen section D301h starts polling in the next clock cycle based on the production order transmitted thereto from the physical layer data production section D301j. Thereafter, a cell is transmitted from the physical layer side, and RxSOH=‘H’ is inputted at the top of the cell (step S25).

Here, the flow for detecting the bit width-cell length passes a route denoted by bit width-cell length detection flow and processing in step S26 is performed while the flow for detecting a physical layer number passes another route denoted by PHY number detection flow and processing in step S33 is performed.

Then, the cell length inspection request outputting section D301f recognizes RxSOH=‘H’ and outputs a bit width-cell length inspection request to the bit width-cell length detection section D303 (step S26). Meanwhile, the physical layer inspection request outputting section D301b outputs a physical layer number inspection request and a counting method notification signal to the physical layer number detection section D304 (step S33). Further, after RxSOC=‘H’ of the second cell is inputted (step S27), a bit width and cell length inspection result is transmitted together with a decision signal from the bit width-cell length detection section D303 (step S28). The cell length inspection request outputting section D301f receives the decision signal and cancels the bit width-cell length inspection request to the bit width-cell length detection section D303 (step S29).

The physical layer data production section D301j is notified of the inspection result and the decision signal from the physical layer number detection section D304 (step S34) and stores the inspection result. It is to be noted that, since the number of physical layers is unknown, it cannot be discriminated when a physical layer number inspection result and a decision signal are transmitted. Therefore, when an inspection result and a decision signal are transmitted to the physical layer inspection request outputting section D301b, the physical layer inspection request outputting section D301b cancels the physical layer number inspection request (step S35) and the physical layer data production section D301j stores the inspection result.

Then, when the reception of the second cell comes to an end (step S30), the Enb_Gen section D301g changes RxEnb to RxEnb=‘H’ (step S31). At this point of time, if also the physical layer number is decided, then physical layer data is produced, but if the physical layer number is not decided, then physical layer data (PHY layer data) is produced after it is waited that the physical layer number is decided (step S32).

Here, as regards the physical layer number, the data transmitted from the physical layer number detection section D304 is utilized but not as it is, but where the current mode is the single Clav mode of the level 2 or in the single Clav mode of the level 3, 1 is added to the physical layer number inspection result and the sum is determined as a physical layer whereas, where the current mode is the multi-Clav mode of the level 2, 4 is added to the physical layer number inspection result and the sum is determined as a physical layer number.

The physical layer information produced through any of the three different routes described above is outputted to the UTOPIA circuit C107 in step S36. Simultaneously, also a start signal is outputted to the UTOPIA circuit C107. The select signal is used for selection of the UTOPIA circuit C107.

In this manner, where the number of RxClav=‘H’ is 0, a flow after RxSOH=‘H’ is inputted is bifurcated, and a bit width and a cell length are detected by the flow in the leftward direction whereas a physical layer number is detected by the flow in the rightward direction.

Through the bifurcation, a result transmitted from the physical layer number outputting section D304c can be discriminated at any stage while the first cell is being received without depending upon the number of connected physical layers.

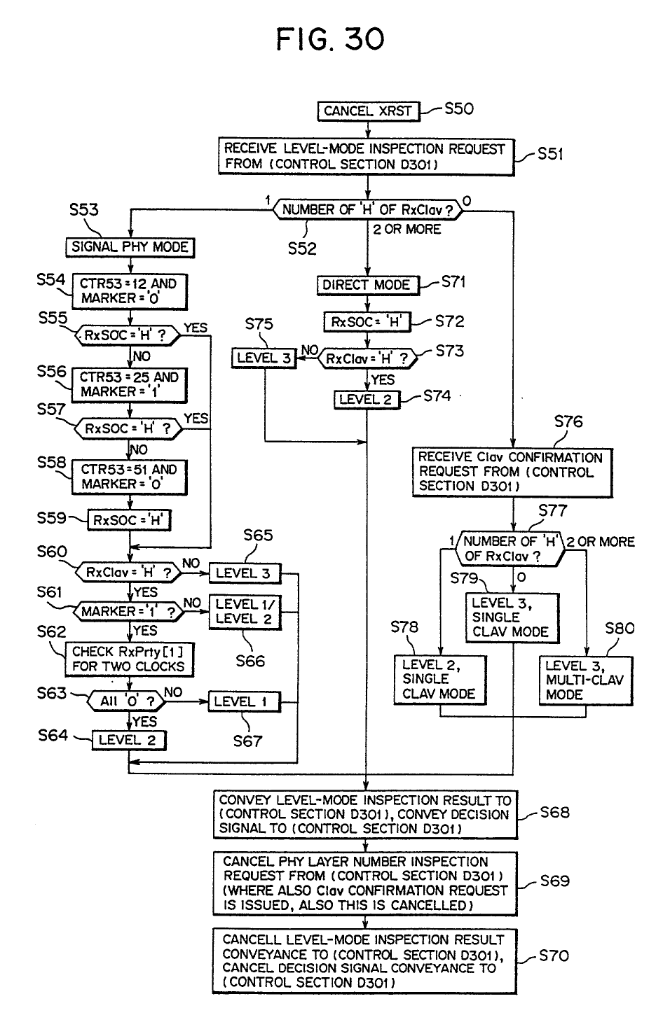

Subsequently, operation of the level-mode detection section D302 is described with reference to FIG. 30. FIG. 30 is a flow chart illustrating operation of the level-mode detection section D302.

Referring to FIG. 30, after the power-on reset state is canceled in step S50, the condition extraction section D302a of the level-mode detection section D302 receives a level-mode inspection request from the control section D301 (step S51), and the condition extraction section D302a recognizes the number of ‘H’ of RxClav based on data from the Clav_Chk section D302c and notifies the detection result production section D302e of the number of ‘H’ . Then, the detection result production section D302e branches a later flow for detection based on the number of ‘H’.

In the following, operation flows which depend upon the number of ‘H’ of RxClav in step S52 are described.

First, when the number of RxClav=‘H’ is 1, it is discriminated that the current mode is the level 1 operation mode (single PHY mode) (step S53) The detection result production section D302e does not operate until RxSOH=‘H’ (RxSOC of the second cell) is inputted, and the CTR_Chk section D302d supervises the value of the 53-nary counter D305 until RxSOC=‘H’ of the second cell is inputted. If CTR53=‘12’ is inputted, then the CTR_Chk section D302d sets the marker to ‘0’ (step S54). Thereafter, if CTR53=‘25’ is inputted while RxSOC=‘H’ remains not inputted (NO route in step S55), then the CTR_Chk section D302d sets the marker to ‘1’ (step S56).

Thereafter, if CTR53=‘51’ is inputted while RxSOC=‘H’ is not inputted (NO route in step S57), then the CTR_Chk section D302d sets the marker to ‘0’ again (step S58). Thereafter, RxSOC=‘H’ is inputted after several clocks (step S59), and the detection result production section D302e starts its operation.

If RxSOH is ‘H’ in each of steps S55 and S57, then the YES route is passed, and processing in step S60 et seq. is performed.

In step S60, it is inspected whether or not RxClav[0]=‘H’. If RxClav[0] is not ‘H’, then the NO route is passed, and it is settled that the current level is the level 3 (step S65). On the contrary if RxClav[0] is ‘H’, then the YES route is passed, and it is discriminated in step S61 whether or not the marker is ‘1’. If the marker is not ‘1’, then the NO route is passed, and it is decided in step S66 that the current level is the level 1 or the level 2.

If the marker is ‘1’ in step S61, then the YES route is passed, and in step S62, RxPrty[1] is inspected for a time of two clocks to detect whether or not both of RxPrty[1] are ‘0’ (step S63). Then, if both of RxPrty[1] are not ‘0’, then the NO route is passed, and in step S67, it is discriminated that the current level is the level 1. However, if both of RxPrty[1] are ‘0’, then the YES route is passed, and it is discriminated in step S64 that the current level is the level 2.

Then, if the number of RxClav=‘H’ is two or more in step S52, then since this indicates the direct mode (step S71), when RxSOC=‘H’ (RxSOC of the second cell) is inputted (step S72), it is discriminated in step S73 whether or not RxClav[0]=‘L’. If RxClav[0]=‘L’, then the NO route is passed, and it is decided that the current level is the level 3 (step S75). However, if RxClav[0]=‘H’, then it is settled that the current level is the level 2 (step S74).

Further, if the number of RxClav=‘H’ is 0 in step S52, then the a Clav confirmation request is inputted from the control section D301 (step S76) and recognized by the detection result production section D302e. Then in step S77, the number of ‘H’ of RxClav is counted based on the data from the Clav_Chk section D302c. If the number is 0, then the route denoted by 0 is passed, and it is decided that the current mode is the single Clav mode of the level 3 (step S79). Similarly, if the number is 1, then the route denoted by 1 is passed, and it is decided that the current mode is the single Clav mode of the level 2. If the number is two or more, then the route denoted by two or more is passed, and it is decided that the current mode is the multi-Clav mode of the level 3 (step S80).

In step S68, data of a level and a mode detected along any of the three different routes described above are conveyed as a level-mode inspection result from the detection result production section D302e to the control section D301, and also a decision signal is conveyed simultaneously. Thereafter, the physical layer number inspection request (PHY layer number inspection request) from the control section D301 is cancelled. Further, if a Clav confirmation request is being outputted, then also the Clav confirmation request is cancelled (step S69). The condition extraction section D301i thus cancels the notification to the detection result production section D302e. Consequently, the detection result production section D302e cancels the level-mode inspection result and the decision signal (step S70).

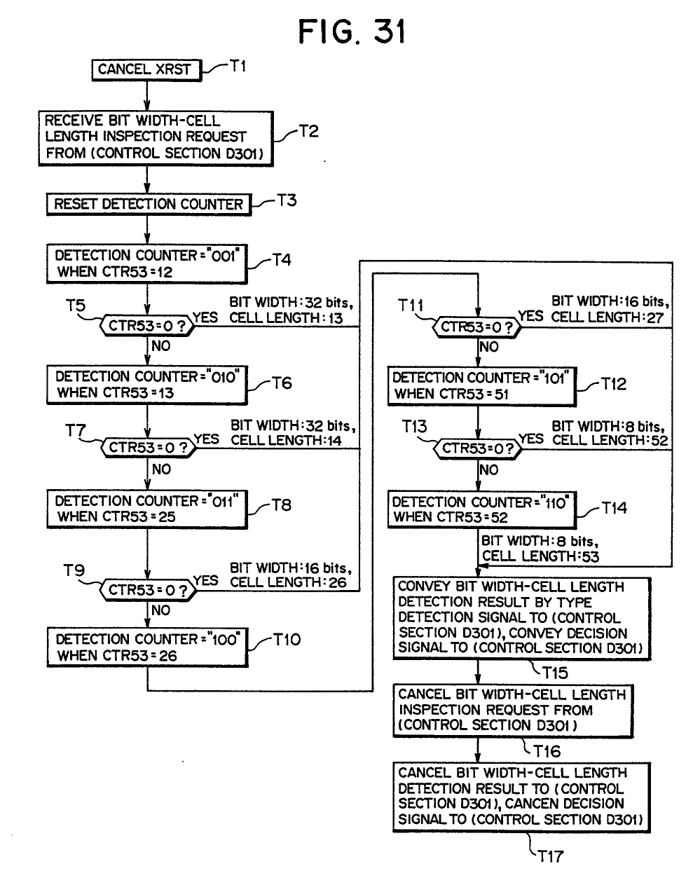

Now, operation of the bit width-cell length detection section D303 is described with reference to FIG. 31. FIG. 31 is a flow chart illustrating operation of the bit width-cell length detection section D303.

First, after the power-on reset state is cancelled (step T1), when a bit width-cell length inspection request is inputted from the control section D301 to the bit width-cell length detection section D303 (step T2), the detection counter is reset (re-loaded) (step T3), and counting up is resumed.

Then, an inspection regarding the five different patterns is performed. First, where the bit width is 32 and the cell length is 13, when the 53-nary counter D305 is 12, the detection counter is set to ‘001’ (step T4). In step T5, it is discriminated whether or not the 53-nary counter D305 is ‘0’. If the 53-nary counter D305 is ‘0’, then the YES route is passed, and processing in step T15 et seq. is performed. On the other hand, if the 53-nary counter D305 is not ‘0’, then the NO route is passed, and the processing advances to step T6.

Where the bit width is 32 and the cell length is 14, when the 53-nary counter D305 is 13, the detection counter is set to ‘010’ in step T6. Then in step T7, it is inspected whether or not the 53-nary counter D305 is ‘0’. If the 53-nary counter D305 is ‘0’, then the YES route is passed, and processing in step T15 et seq. is performed. But if the 53-nary counter D305 is not ‘0’, then the processing passes the NO route and advances to step T8.

Where the bit width is 16 and the cell length is 26, when the 53-nary counter D305 is 25, the detection counter is set to ‘011’ in step T8. In step T9, it is inspected whether or not the 53-nary counter D305 is ‘0’. If the 53-nary counter D305 is ‘0’, then the YES route is passed, and processing in step T15 et seq. is performed. However, if the 53-nary counter D305 is not ‘0’, then the processing passes the NO route and advances to step T10.

Where the bit width is 16 and the cell length is 27, when the 53-nary counter D305 is 26, the detection counter is set to ‘100’ in step T10. In step T11, it is inspected whether or not the 53-nary counter D305 is ‘0’. If the 53-nary counter D305 is ‘0’, then the YES route is passed and processing in step T15 et seq. is performed. On the other hand, if the 53-nary counter D305 is not ‘0’, then the processing passes the NO route and advances to step T12.

Similarly, where the bit width is 16 and the cell length is 27, when the 53-nary counter D305 is 51, the detection counter is set to ‘101’ in step T12, and in step T13, it is inspected whether or not the 53-nary counter D305 is ‘0’. If the 53-nary counter D305 is ‘0’, then the YES route is passed and processing in step T15 et seq. is performed. On the other hand, if the 53-nary counter D305 is not ‘0’, then the processing passes the NO route and advances to step T14.

Where the bit width is 8 and the cell length is 52, when the 53-nary counter D305 is 52, the detection counter is set to ‘110’ in step T14.

In step T15, the detection result production section D303b recognizes a bit width-cell length detection request and, when the count value becomes equal to ‘0’, outputs the value of the detection counter as a bit width and cell length inspection result to the control section D301 together with a decision signal. Thereafter, a notification to cancel the bit width-cell length inspection request is outputted from the control section D301 (step T16). Then in step T17, the bit width-cell length detection section D303 cancels the bit width-cell length inspection request to the control section D301 and cancels the bit width and cell length inspection result and the decision signal.

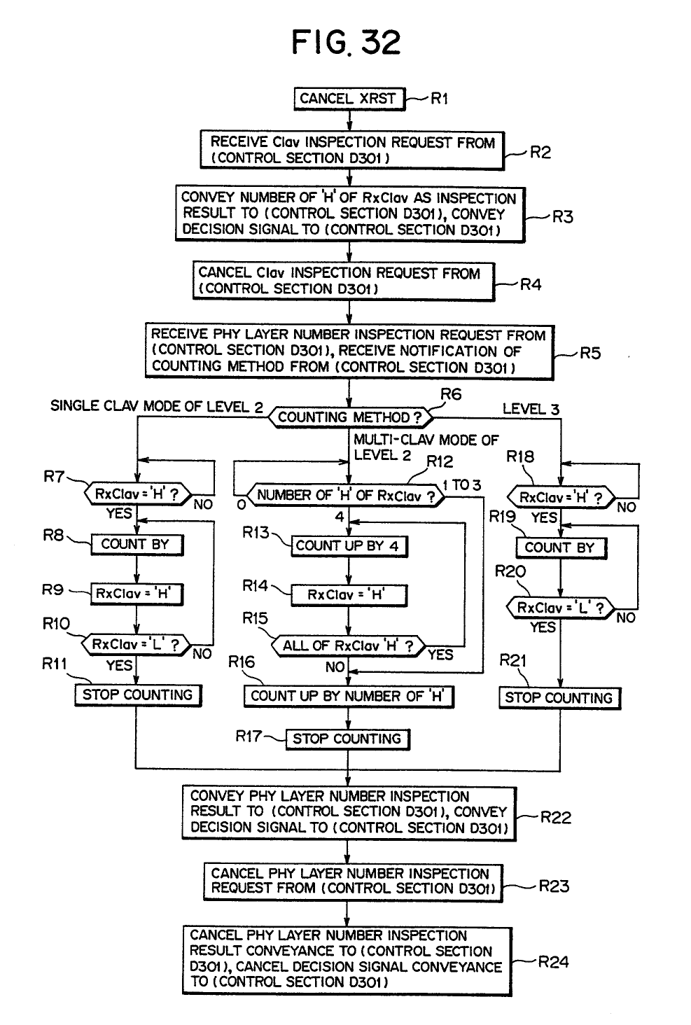

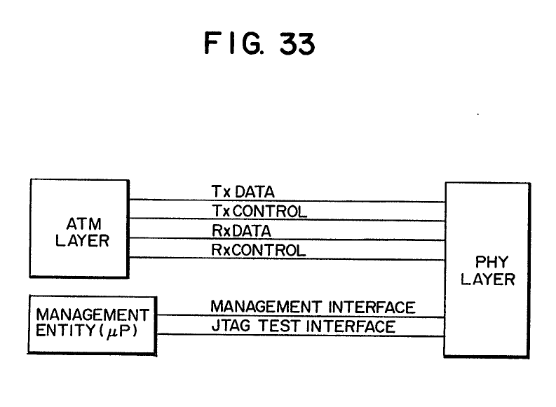

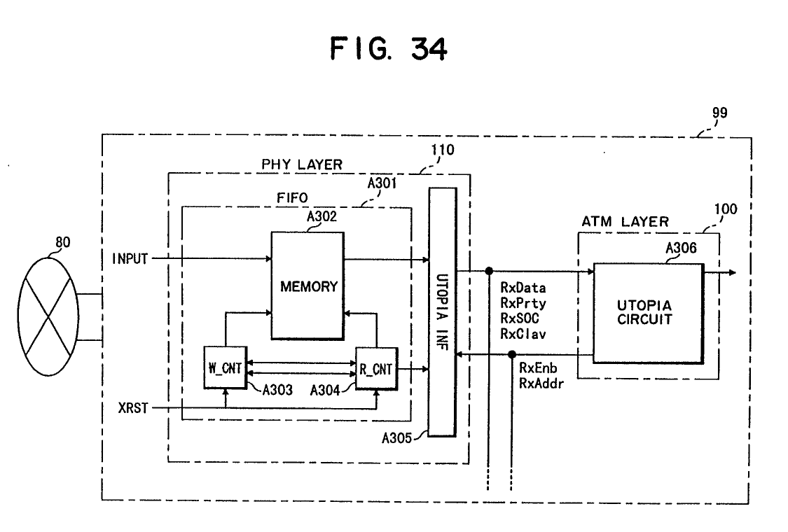

Subsequently, operation of the physical layer number detection section D304 is described with reference to an operation flow of FIG. 32. FIG. 32 is a flow chart illustrating operation of the physical layer number detection section D304.

First, after the power-on reset state is cancelled (step R1), the physical layer number detection section D304 receives a Clav inspection request inputted thereto from the control section D301 (step R2). The Clav confirmation section D304a receives the Clav inspection request and produces a Clav inspection result from data representative of the number of ‘H’ of RxClav from the Clav_Chk section D304d. Further, the Clav confirmation section D304a requests the physical layer number outputting section D304c to output a decision signal to the control section D301 (step R3). Since a physical layer number inspection request has not been issued, the Clav inspection result is selected as an inspection result by the selector D304e and outputted to the control section D301.

Meanwhile, the physical layer number outputting section D304c having been requested to output a decision signal outputs a decision signal to the control section D301. Then in step R4, the control section D301 cancels the Clav confirmation request, and consequently, the Clav confirmation section D304a stops its outputting of the Clav inspection result and cancels the request having been outputted to the physical layer number detection section D304. Consequently, the physical layer number detection section D304 cancels the decision signal.

Thereafter, in step R5, when detection of the physical layer number becomes necessary depending upon the level and the mode, the physical layer number detection section D304 receives a physical layer number inspection request (PHY layer number inspection request) and a counting method notification signal inputted thereto from the control section D301. The Clav_Chk section D304d receives them and notifies the physical layer number counter section D304b of the number of RxClav=‘H’ for each one clock. Consequently, the physical layer number counter section D304b counts up by the received number.

If the conveyed counting method is the single Clav mode of the level 2 in step R6, then the-processing of the Clav_Chk section D304d passes the route denoted by level 2-single Clav mode, and the Clav_Chk section D304d inspects in step R7 whether or not RxClav=‘H’. If RxClav is not ‘H’, then the NO route is repetitively passed, but when RxClav is ‘H’, the YES route is passed, and the counter counts up in step R8. Further, in step R9, RxClav is changed to RxClav=‘L’, and it is discriminated in step R10 whether or not RxClav=‘L’.

If RxClav is not RxClav=‘L’, then the NO route is passed and the processing in step R8 et seq. is performed. However, if RxClav=‘L’, then the YES route is passed, and the counting is stopped in step R11.

On the other hand, where RxClav[0]=‘L’ is inputted successively in two clocks in step R6, if the current mode is the multi-Clav mode of the level 2, then the number of ‘H’ of RxClav is counted in step R12. Here, while the number remains 0, the processing repetitively passes the route denoted by 0, but where the number is one of 1 to 3, the processing passes the route denoted by 1 to 3, and processing in step R16 et seq. is performed.

Further, if the number is 4, then the counter counts up by 4 in step R13, and RxClav is set to RxClav=‘L’ (step R14). Then in step R15, it is inspected whether or not all of RxClav are ‘H’. Here, if all of RxClav are ‘H’, then the processing passes the YES route and processing beginning with step R13 is performed, but otherwise, the NO route is passed and the counter counts up by a number equal to the number of ‘H’ in step R16. Then in step R17, the counting is stopped.

If ‘L’ is inputted successively in two clocks to one of RxClav[3:0] in step R6, then the processing passes the route denoted by level 3, and it is inspected in step R18 whether or not RxClav=‘H’. Then, while RxClav is not ‘H’, the processing repetitively passes the NO route, but when RxClav becomes ‘H’, then the processing passes the YES route, and the counter counts up in step R19. Further, in step R20, it is inspected whether or not RxClav=‘L’. If RxClav is not RxClav=‘L’, then the NO route is passed and processing in step R19 et seq. is performed. However, if RxClav=‘L’, then the YES route is passed, and the counting is stopped in step R21.

Then, if the current level is the level 3, then when RxClav[0] is inputted even during one clock, the physical layer number detection section D304 is notified that the counting of the physical layer number comes to an end. Then in step R22, the physical layer number detection section D304 receives the notification and outputs the count value of the physical layer number counter section D304b as a physical layer number inspection result. The physical layer number inspection request is inputted also to the selector D304e, and the count value output is selected by the selector D304e and outputted as an inspection result to the control section D301. Further, the physical layer number detection section D304 outputs a decision signal to the control section D301 simultaneously with the outputting of the inspection result.

Thereafter, the physical layer number inspection request is cancelled in step R23. Further, in step R24, the selection by the selector D304e is changed to an output of the Clav confirmation section D304a and the outputting of the inspection result is cancelled. Further, the Clav_Chk section D304d recognizes the cancellation of the physical layer number inspection request and cancels an alarm having been outputted to the physical layer number detection section D304. Consequently, the physical layer number detection section D304 cancels the decision signal and cancels also the outputting of the inspection result.

In this manner, the asynchronous transfer mode communication apparatus can cope with all of the modes (the levels 1, 2, 3 and the single Clav mode, direct mode and multi-Clav mode as well as 8 bits, 16 bits and so forth) of the UTOPIA specifications prescribed by the ATM forum without any setting from the outside, and can effectively perform communication of ATM cell data.

Further, mode setting is automatically detected by hardware in this manner, and setting such as a change of a mode in accordance with an operation condition by a user is not required any more. Further, ATM cells can be transferred in a high efficiency and with a high quality, and expandability and universality can be anticipated.

Further, since all cell information such as a level, a mode, presence or absence of a UDF, a bit width, and a parity addition method is recognized in advance in this manner, the UTOPIA circuit of the ATM layer side can cope individually with all modes where all cell information such as a level, a mode, presence or absence of a UDF, a bit width and a parity adding method is recognized in advance.

Further, the asynchronous transfer mode communication apparatus can cope with all modes of the UTOPIA specifications prescribed by the ATM forum without any setting from the outside and can effectively perform communication of ATM cell data and besides can reduce the scale of hardware.

### B. Others

The present invention is not limited to the embodiment specifically described above, and variations and modifications can be made without departing from the scope of the present invention.

The present invention can be applied not only to reception but also to transmission in the UTOPIA specifications prescribed by the ATM forum.

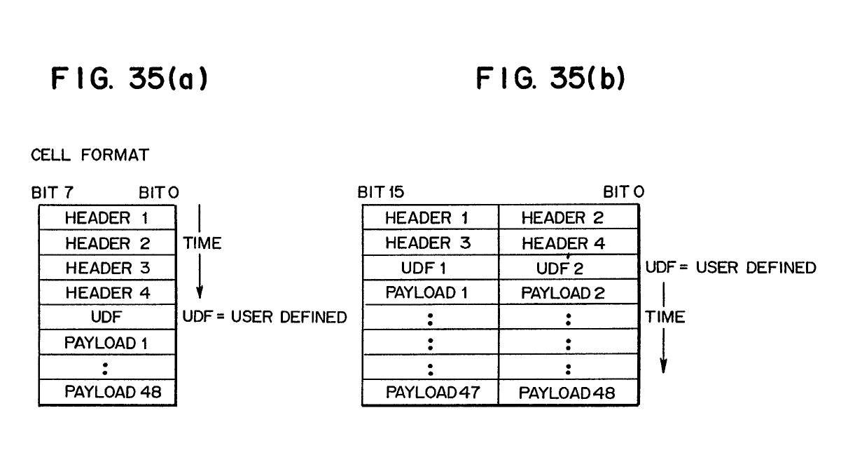

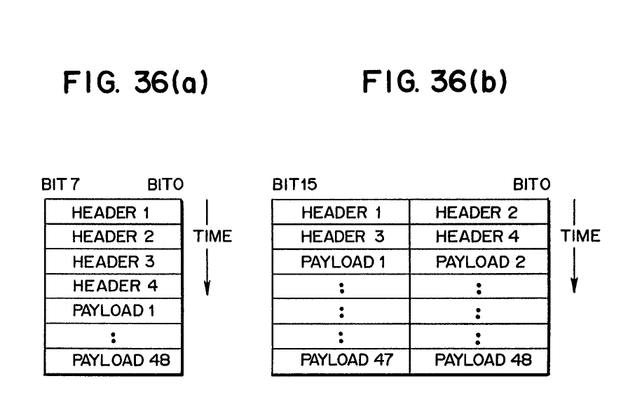

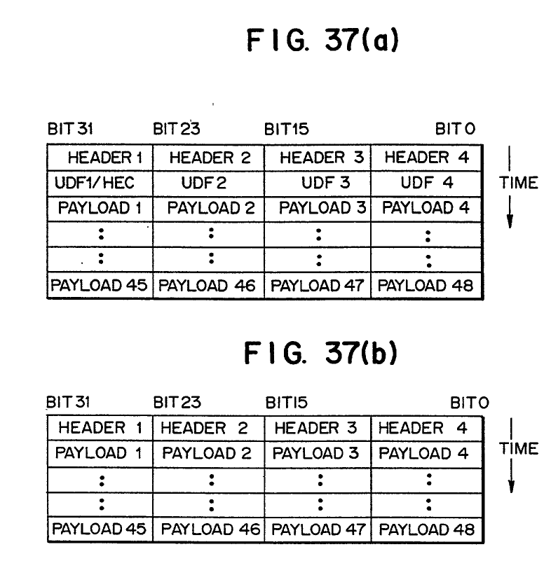

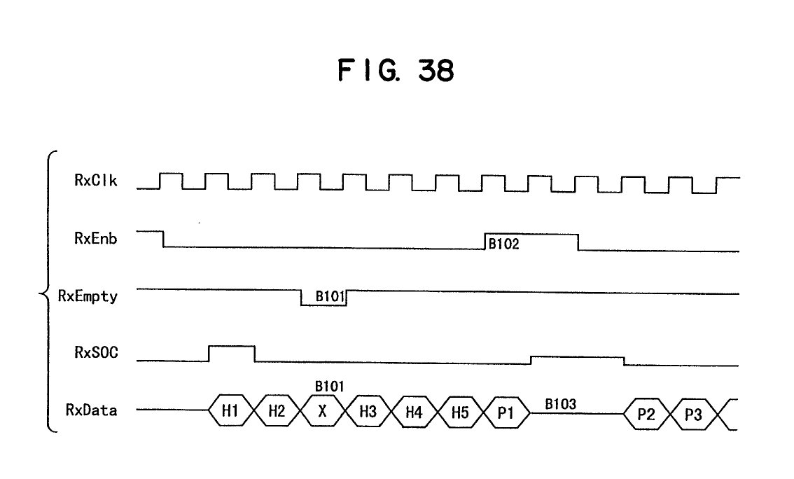

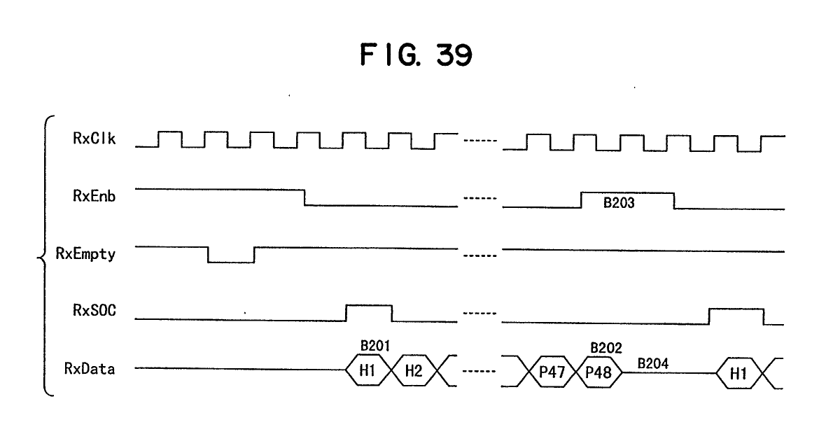

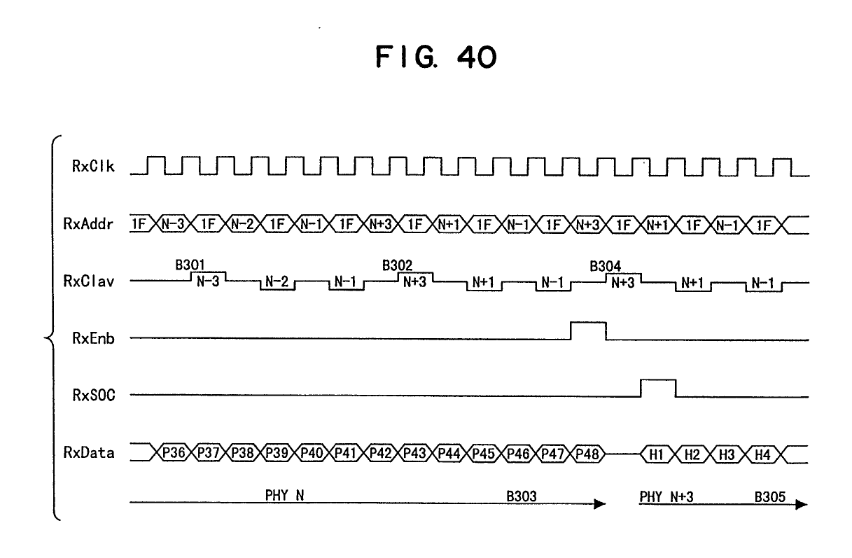

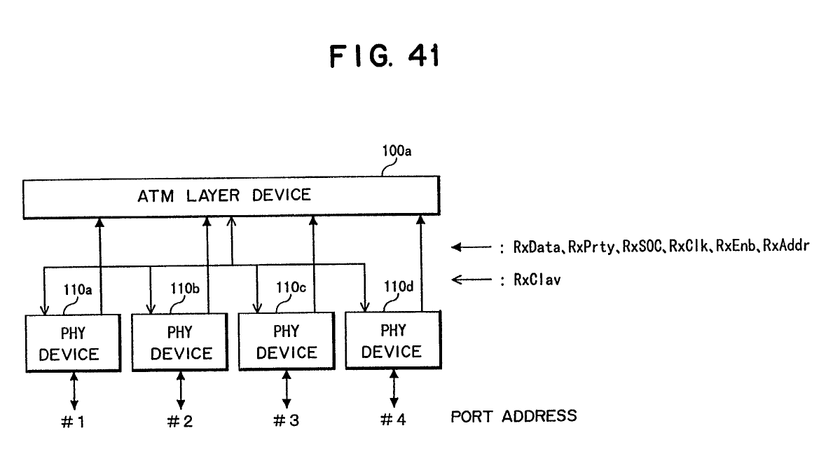

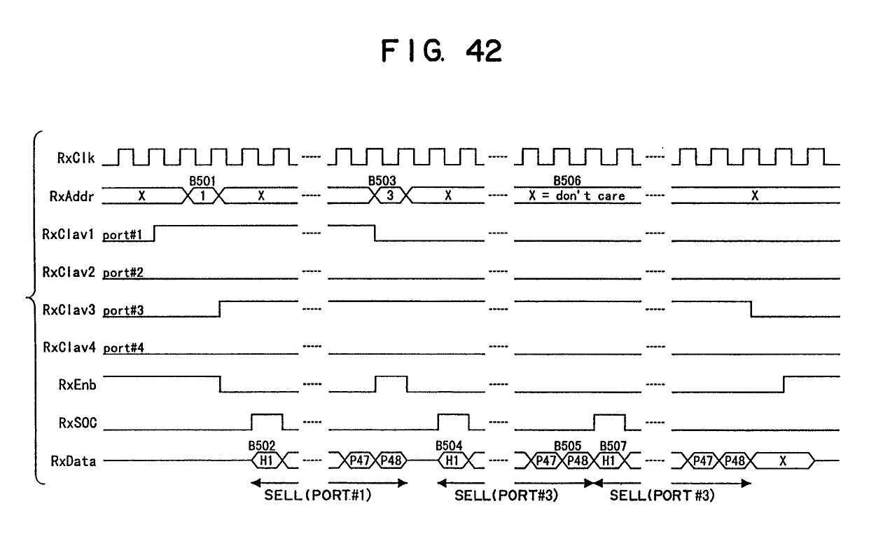

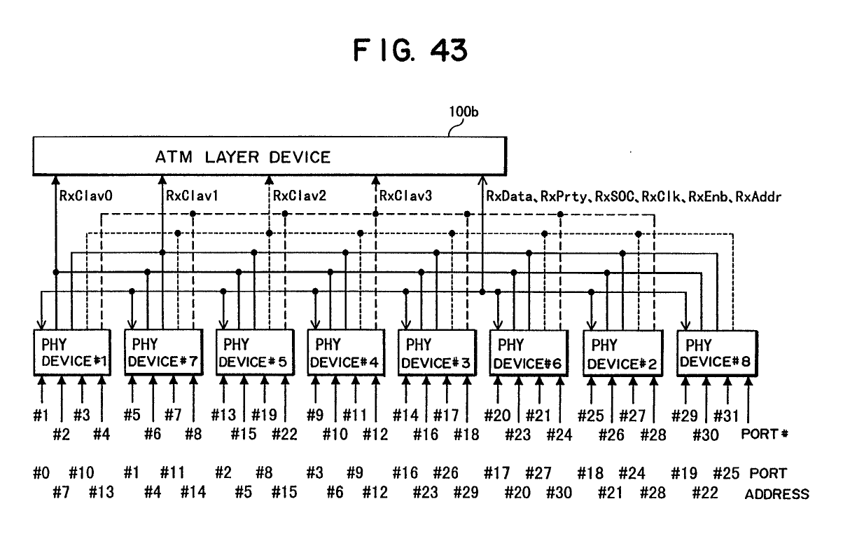

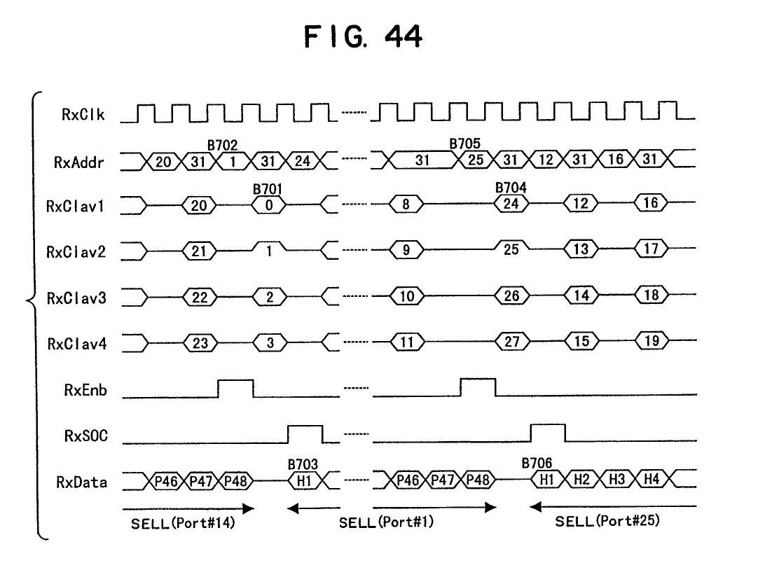

In FIG. 5, the clock signal on the physical layer side is represented as PHY (Write) CLK while the clock signal on the ATM layer side is represented as ATM (Read) CLK. In FIGS. 7 and 35 to 37, Bit represents a bit position. In FIGS. 8 to 27, ‘X’ represents don't care. In FIGS. 30 to 32, (D301) represents the control section D301.

Further, in the present invention, in initial operations of the RAM section D103 of the FIFO processing section C100 or D100 of the physical layer side, two particular cells for detection are not written into the RAM section D103 after the power-on reset state is canceled in any of a case wherein the write side selects cell production for detection and another case wherein the read side selects cell production for detection. In other words, in the present invention, only when the write side is selected, particular cells for detection are written into the RAM section D103 after the power-on reset state is cancelled.

When the write side is selected in FIG. 5, no cell is written into the RAM section D103, and when a request for signaling a cell is received from the ATM layer side, a particular cell is signaled from the detecting cell production section D115 and selected by the selector D117 so that it is signaled to the ATM layer side for a time until a detection operation comes to an end (for a time until two cells are read out).

What is claimed is:

1. An asynchronous transfer mode layer side interface apparatus which uses an interface representative of a signal interface between a physical layer and an asynchronous transfer mode layer in an asynchronous transfer mode, comprising:
a detection circuit connected to a physical layer side interface apparatus and capable of extracting physical layer data regarding the interface from an interface signal outputted from said physical layer side interface apparatus and outputting data originating from the physical layer data and first address information;
a circuit connected to said detection circuit and capable of outputting information data received by said physical layer side interface apparatus to a higher order layer based on the physical layer data and outputting second address information; and
a selection section connected to said detection circuit and said circuit and capable of selectively outputting the first address information and the second address information.

2. The asynchronous transfer mode layer side interface apparatus as claimed in claim 1, wherein said detection circuit includes:
a level-mode detection section connected to said physical layer side interface apparatus and capable of detecting at least a level, a mode and a polling method from the physical layer data;
a physical layer number detection section connected to said physical layer side interface apparatus and capable of detecting the number of connection ports of said physical layer side interface apparatus;
a bit width-cell length detection section capable of detecting at least a bit width and a cell length of the interface signal; and
a control section connected to said level-mode detection section and said physical layer number detection section and capable of outputting data based on the level, mode and polling method detected by said level-mode detection section, a start signal representing that a cell of the asynchronous transfer mode has been received and a selection signal for switching between said detection circuit and said circuit.

3. The asynchronous transfer mode layer side interface apparatus as claimed in claim 1, wherein said detection circuit extracts, from a Clav signal having status information representative of whether or not reception of an asynchronous transfer mode call is possible, the status information and an inspection result regarding at least a level and a mode and sets physical layer data regarding the interface.

4. A physical layer side interface apparatus which uses an interface representative of a signal interface between a physical layer and an asynchronous transfer mode layer in an asynchronous transfer mode, comprising:
holding means capable of holding an initialization cell to be used to detect physical layer data regarding the interface;
write side detecting cell production means connected to the input side of said holding means and capable of writing the initialization cell;
read side detecting cell production means connected to the output side of said holding means and capable of writing the initialization cell; and
switching means connected to said write side detecting cell production means and said read side detecting cell production means and capable of selectively switching so that one of said write side detecting cell production means and said read side detecting cell production means is write enabled and the other of said write side detecting cell production means and said read side detecting cell production means is write inhibited.

5. A cell processing method for an asynchronous transfer mode layer side interface apparatus which uses an interface representative of a signal interface between a physical layer and an asynchronous transfer mode layer in an asynchronous transfer mode, comprising:
a writing step performed by a physical layer side interface apparatus of writing an initialization cell to be used to detect physical layer data regarding said interface;
a detection step per formed by said asynchronous transfer mode layer side interface apparatus of detecting physical layer data regarding the interface from a signal having a level and a mode; and
a reception cell processing step performed by said asynchronous transfer mode layer side interface apparatus of outputting information data and second address information received by said physical layer side interface apparatus based on the physical layer data obtained by the detection step to a higher order layer.

6. A cell processing method between a physical layer side interface apparatus and an asynchronous transfer mode layer side interface apparatus which uses an interface representative of a signal interface between a physical layer and an asynchronous transfer mode layer in an asynchronous transfer mode, comprising:
a switching step of selectively switching one of input side writing means and output side writing means in order to write an initialization cell provided in said physical layer side interface apparatus into holding means which is capable of storing the initialization cell;
a cell writing step performed by the writing means selected in the switching step of writing the initialization cell into said holding means; and
a processing step of permitting, when said input side writing means is selected, inputting of a clock signal outputted from said asynchronous transfer mode layer side interface apparatus to allow the initialization cell to be written into said holding means but reading out, when said output side writing means is selected, the initialization cell while masking part of a read enable flag stored in said holding means and then canceling the masking of the read enable flag to allow the initialization cell to be written into said holding means.

7. An asynchronous transfer mode communication apparatus which uses an interface representative of a signal interface between a physical layer and an asynchronous transfer mode layer in an asynchronous transfer mode, comprising:
a physical layer side interface apparatus for transmitting and receiving an interface signal; and
an asynchronous transfer mode layer side interface apparatus for transmitting and receiving the interface signal;
said asynchronous transfer mode layer side interface apparatus including a detection circuit connected to said physical layer side interface apparatus and capable of extracting physical layer data regarding the interface from an interface signal outputted from said physical layer side interface apparatus and outputting data originating from the physical layer data and first address information, a circuit connected to said detection circuit and capable of outputting information data received by said physical layer side interface apparatus to a higher order layer based on the physical layer data and outputting second address information, and a selection section connected to said detection circuit and said circuit and capable of selectively outputting the first address information and the second address information;
said physical layer side interface apparatus including holding means capable of holding an initialization cell to be used to detect physical layer data regarding the interface; write side detecting cell production means connected to the input side of said holding means and capable of writing the initialization cell, read side detecting cell production means connected to the output side of said holding means and capable of writing the initialization cell, and switching means connected to said write side detecting cell production means and said read side detecting cell production means and capable of selectively switching so that one of said write side detecting cell production means and said read side detecting cell production means is write enabled and the other of said write side detecting cell production means and said read side detecting cell production means is write inhibited.
